(19) United States
(12) Patent Application Publication
(10) Pub. No.: US 2024/0343455 A1
(43) Pub. Date: Oct. 17, 2024

(54) CONTAINER WITH MAGNETIC CAP

(71) Applicant: YETI Coolers, LLC, Austin, TX (US)

(72) Inventors: Mark D. Miller, San Marcos, TX (US); Derek G. Sullivan, Austin, TX (US); Roy Joseph Seiders, Austin, TX (US); John Alan Tolman, Austin, TX (US); Steve Nichols, Austin, TX (US)

(21) Appl. No.: 18/613,429

(22) Filed: Mar. 22, 2024

Related U.S. Application Data
(63) Continuation-in-part of application No. 18/368,718, filed on Sep. 15, 2023.
Application No. 18/368,718 is a continuation of application No. 17/677,637, filed on Feb. 22, 2022, now Pat. No. 11,794,960.
Application No. 17/677,637 is a continuation of application No. 17/152,503, filed on Jan. 19, 2021, now Pat. No. 11,273,961.
Application No. 17/152,503 is a continuation of application No. 16/154,178, filed on Oct. 8, 2018, now Pat. No. 10,926,925.
Application No. 16/154,178 is a continuation of application No. 14/826,612, filed on Aug. 14, 2015, now Pat. No. 10,093,460.

(51) Int. Cl. B65D 47/14; B65D 1/02; B65D 25/28; B65D 25/40; B65D 41/04; B65D 43/02; B65D 51/24; B65D 55/16; B65D 81/38

(52) U.S. Cl. CPC B65D 47/14; B65D 1/0246; B65D 25/2835; B65D 25/2864; B65D 25/40; B65D 41/04; B65D 43/0229; B65D 47/142; B65D 51/242; B65D 55/16; B65D 81/3837; B65D 81/3841; B65D 2525/283; B65D 2543/00351

(57) ABSTRACT

A container having a canister can be configured to retain a volume of liquid. The canister can be sealed by a lid structure, and the lid structure can have a spout opening. The spout opening may be sealed by a removably-coupled cap. Further, the cap may have a magnetic top surface configured to magnetically couple to a recess on the top surface of the lid for temporary storage of the cap when manually removed from the spout opening. Further, the lid structure may have one or more of an integrated anti-glug venting feature within the removable lid and cap or handle indexing.

### CROSS-REFERENCE TO RELATED APPLICATIONS

This application is a continuation-in-part of U.S. patent application Ser. No. 18/368,718, filed Sep. 15, 2023, which is a continuation of U.S. patent application Ser. No. 17,677,637, filed Feb. 22, 2022, now U.S. Pat. No. 11,794,960, which is a continuation of U.S. patent application Ser. No. 17/152,503, filed Jan. 19, 2021, now U.S. Pat. No. 11,273,961, which is a continuation of U.S. patent application Ser. No. 16/154,178, filed Oct. 8, 2018, now U.S. Pat. No. 10,926,925, which is a continuation of U.S. patent application Ser. No. 14/826,612, filed Aug. 14, 2015, now U.S. Pat. No. 10,093,460, each of which is incorporated herein by reference in its entirety for any and all non-limiting purposes.

### BACKGROUND

A container may be configured to store a volume of liquid. In one example, an opening in the container may be sealed with a removable cap. As such, in order to extract the liquid from the container, the cap may first be manually removed and set aside.

### BRIEF SUMMARY

In certain examples, an insulating container may have a canister, which can include an insulated double wall, a first end to support the canister on a surface, a second end, and a sidewall. The canister may also have an opening in the second end that extends through the insulated double wall. A neck structure may encircle the opening and extend in an axial direction.

In certain examples, a lid may seal the opening of the canister, with a neck structure encircling the opening and extending in an axial direction and a cap may be adapted to resealably seal the spout. The lid may comprise: a threaded sidewall configured to be received into the neck structure; a top surface with a spout, wherein the spout extends from the top surface of the lid; a vent cavity extending from a bottom surface of the lid to the spout; and a vent body configured to fit into the vent cavity. The vent body, the vent cavity, the spout, and the bottom surface of the lid define a vent that extends from the spout to the bottom surface of the lid and into the canister.

The lid may also have a circular domed top surface having a spout opening, and a removable cap that seals the spout opening. Further, the cap may have a magnetic top surface configured to be magnetically attracted to, and retained within, an optional dimple on the domed top surface.

In certain examples, an insulating container may comprise a bottom portion, a lid, a cap, and a carry handle. The bottom portion may comprise: a first end configured to support the container on a surface, wherein the first end has a first outer diameter; a second end having an opening, wherein the opening has a second outer diameter smaller than the first outer diameter; a cylindrical wall spaced between the first end and the second end, wherein an outer diameter of the cylindrical wall tapers from the first outer diameter to the second outer diameter along a shoulder chamfer of the cylindrical wall; and a neck structure encircling the opening and extending in an axial direction. The lid may be adapted to resealably seal the opening. Further, the lid may comprise: a threaded sidewall configured to be received into the neck structure; a top surface; a spout with a spout opening, wherein the spout extends through the top surface of the lid and a bottom surface of the lid; a vent cavity extending from the bottom surface of the lid to the spout; and a vent body located within the vent cavity, wherein the vent body, the vent cavity, the spout, and the bottom surface of the lid define a vent that extends from the spout to the bottom surface of the lid and into the container. The cap may be adapted to resealably seal the spout opening. The carry handle may be rotatably coupled to a cylindrical sidewall of the lid. The carry handle may include a handle index that locks the carry handle at a zero-degree position or horizontal-right, a 90-degree position or vertical, and a 180-degree position or horizontal-left.

In certain examples, a container may comprise a canister and a lid adapted to seal the canister. The canister may comprise: a double wall structure formed of an inner wall and an outer wall; an opening in the second end extending through the double wall structure; and a neck structure encircling the opening and extending in an axial direction. The outer wall may comprise: a first end and a second end. The first end may be configured to support the canister on a surface, wherein the first end includes a base with a base bumper that fits within a circular base slot located on the base, wherein the circular base slot circumferentially extends around the base. The lid may be adapted to seal the opening. The lid may comprise: a threaded sidewall configured to be received into the neck structure; a top surface; a vent cavity; and a vent body located within the vent cavity. The top surface may comprise a spout on the top surface, wherein the spout extends through the top surface and a bottom surface of the lid; and a removable cap adapted to resealably seal the spout. The vent cavity may extend from the bottom surface of the lid to the spout. The vent body, the vent cavity, the spout, and the bottom surface of the lid define a vent that extends from the spout to the bottom surface of the lid and into the container.

This Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

### BRIEF DESCRIPTION OF THE DRAWINGS

The present invention is illustrated by way of example and not limited in the accompanying figures in which like reference numerals indicate similar elements and in which:

FIG. 1 depicts an isometric view of an example container, according to one or more aspects described herein.

FIG. 2 depicts another isometric view of the container of FIG. 1, according to one or more aspects described herein.

FIG. 3 depicts an exploded isometric view of another example container, according to one or more aspects described herein.

FIG. 4 depicts a cross-sectional sectional view of the container of FIG. 3, according to one or more aspects described herein.

FIG. 5 depicts a side view of a canister, according to one or more aspects described herein.

FIG. 6 schematically depicts an end view of the container of FIG. 3, according to one or more aspects described herein.

FIG. 7 schematically depicts a plan view of the container of FIG. 3, according to one or more aspects described herein.

FIG. 8 depicts an example cap structure, according to one or more aspects described herein.

FIG. 9 depicts another example cap structure, according to one or more aspects described herein.

FIG. 10 schematically depicts an isometric view of an example lid structure, according to one or more aspects described herein.

FIG. 11 schematically depicts an isometric view of another example lid structure, according to one or more aspects described herein.

FIG. 12 depicts an isometric view of another example container structure, according to one or more aspects described herein.

FIG. 13 depicts an isometric view of another example container structure, according to one or more aspects described herein.

FIG. 14 depicts another implementation of a container structure, according to one or more aspects described herein.

FIG. 15 depicts a cross-sectional view of the container of FIG. 14, according to one or more aspects described herein.

FIGS. 16A and 16B depict isometric views of another example container, according to one or more aspects described herein.

FIG. 17 depicts an exploded view of the container from FIGS. 16A and 16B, according to one or more aspects described herein.

FIG. 18A depicts a side view of the container from FIGS. 16A and 16B, according to one or more aspects described herein.

FIG. 18B depicts a cross-section view along 18B-18B from FIG. 18A of the container from FIGS. 16A and 16B, according to one or more aspects described herein.

FIG. 19A depicts a side view of the container from FIGS. 16A and 16B, according to one or more aspects described herein.

FIG. 19B depicts a cross-section view along 19B-19B from FIG. 19A of the container from FIGS. 16A and 16B, according to one or more aspects described herein.

FIGS. 20A and 20B depict isometric views of another example container, according to one or more aspects described herein.

FIG. 21 depicts a top perspective view of a canister from the container from FIGS. 16A and 16B, according to one or more aspects described herein.

FIG. 22A depicts a side view of the canister from FIG. 21, according to one or more aspects described herein.

FIG. 22B depicts a cross-section view along 22B-22B from FIG. 22A of the canister from FIG. 21, according to one or more aspects described herein.

FIG. 22C depicts a bottom view of the canister from FIG. 21, according to one or more aspects described herein.

FIG. 22D depicts a close-up view of the top portion labeled 22D of the canister from FIG. 22B of the canister from FIG. 21, according to one or more aspects described herein.

FIG. 22E depicts a close-up view of the bottom portion labeled 22E of the canister from FIG. 22B of the canister from FIG. 21, according to one or more aspects described herein.

FIG. 23A depicts a top perspective view of a base bumper from the container from FIGS. 16A and 16B, according to one or more aspects described herein.

FIG. 23B depicts a bottom perspective view of the base bumper from FIG. 23A, according to one or more aspects described herein.

FIG. 24A depicts a top view of the base bumper from FIG. 23A, according to one or more aspects described herein.

FIG. 24B depicts a cross-section view of the base bumper from FIG. 23A along 24B-24B from FIG. 24A, according to one or more aspects described herein.

FIG. 24C depicts a close-up view of the area labeled 24C of the base bumper from FIG. 24B, according to one or more aspects described herein.

FIGS. 25A and 25B depict perspective views of a lid assembly from the container from FIGS. 16A and 16B, according to one or more aspects described herein.

FIG. 25C depicts a top view of the lid assembly from FIGS. 25A and 25B, according to one or more aspects described herein.

FIG. 26 depicts an exploded component view of the lid assembly from FIGS. 25A and 25B, according to one or more aspects described herein.

FIG. 27A depicts an exploded component view of an indexing handle assembly from the container from FIGS. 16A and 16B, according to one or more aspects described herein.

FIGS. 27B and 27C depict various views of another indexing handle assembly from the container from FIGS. 16A and 16B, according to one or more aspects described herein.

FIG. 28A depicts a side view of the lid assembly from FIGS. 25A and 25B, according to one or more aspects described herein.

FIG. 28B depicts a cross-section view of the lid assembly along 28B-28B from FIG. 28A, according to one or more aspects described herein.

FIG. 28C depicts a cross-section view of a portion of the lid assembly from FIG. 28B, according to one or more aspects described herein.

FIG. 29 depicts an exploded component view of portions of the lid from the container from FIGS. 16A and 16B, according to one or more aspects described herein.

FIGS. 30A and 30B depict perspective views of the lid bottom of the lid from the container from FIGS. 16A and 16B, according to one or more aspects described herein.

FIG. 30C depicts a top view of the lid bottom from FIGS. 30A and 30B, according to one or more aspects described herein.

FIG. 30D depicts a bottom view of the lid bottom from FIGS. 30A and 30B, according to one or more aspects described herein.

FIG. 31A depicts a side view of the lid bottom from FIGS. 30A and 30B, according to one or more aspects described herein.

FIG. 31B depicts a cross-section view of the lid bottom along 31B-31B from FIG. 31A, according to one or more aspects described herein.

FIG. 32A depicts a side view of the lid bottom from FIGS. 30A and 30B, according to one or more aspects described herein.

FIG. 32B depicts a cross-section view of the lid bottom along 32B-32B from FIG. 32A, according to one or more aspects described herein.

FIGS. 33A-33E depict various views of a vent portion that fits into the lid bottom from FIGS. 30A and 30B, according to one or more aspects described herein.

FIG. 34A depicts a side view of the vent portion from FIGS. 33A-33E, according to one or more aspects described herein.

FIG. 34B depicts a cross-section view of the vent portion along 34B-34B from FIG. 34A, according to one or more aspects described herein.

FIGS. 35A and 35B depict views of portions of vent portion from FIGS. 33A-33E, according to one or more aspects described herein.

FIG. 36A depicts a side view of the lid assembly with the vent portion from FIGS. 33A-33E, according to one or more aspects described herein.

FIG. 36B depicts a cross-section view of the lid assembly along 36B-36B from FIG. 36A, according to one or more aspects described herein.

FIGS. 37A and 37B depict various view of another vent portion that fits into the lid bottom from FIGS. 30A and 30B, according to one or more aspects described herein.

FIGS. 38A-38C depict the pouring of the container from FIGS. 16A and 16B, according to one or more aspects described herein.

Further, it is to be understood that the drawings may represent the scale of different components of one single embodiment; however, the disclosed embodiments are not limited to that particular scale.

### DETAILED DESCRIPTION

Aspects of this disclosure relate to a container configured to store a volume of liquid. In one example, the container and lid assembly may include an integrated anti-glug venting feature within a removable lid and cap. The container may also include a spring-ball detent for handle indexing. The container may also include features for helping the user hold the container, such as a base bumper and/or grip ring. In another example, the container may have a spout opening that is sealed with a removable cap. Accordingly, the removable cap may be configured with a magnetic top surface such that when removed, the cap may be magnetically affixed to one or more surfaces of the container for temporary storage while the liquid is being poured from the container.

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope and spirit of the present disclosure.

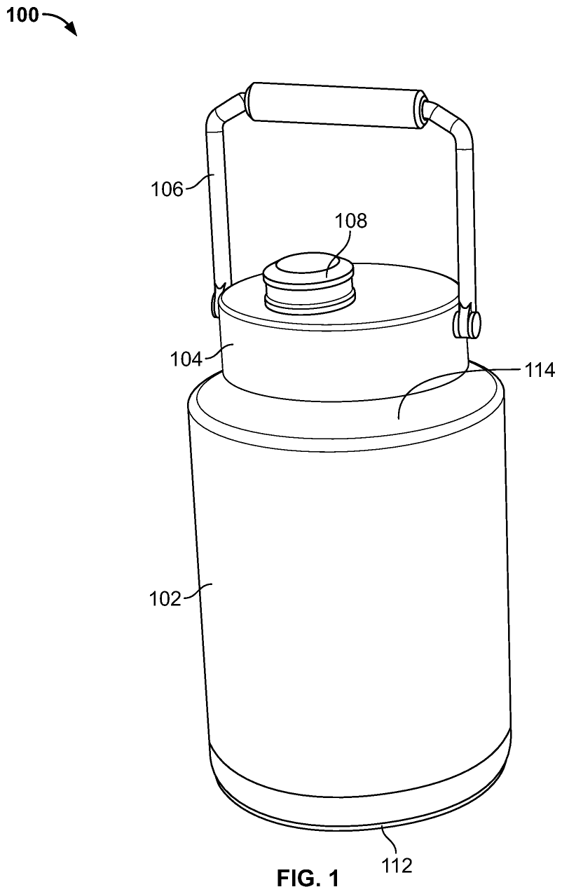

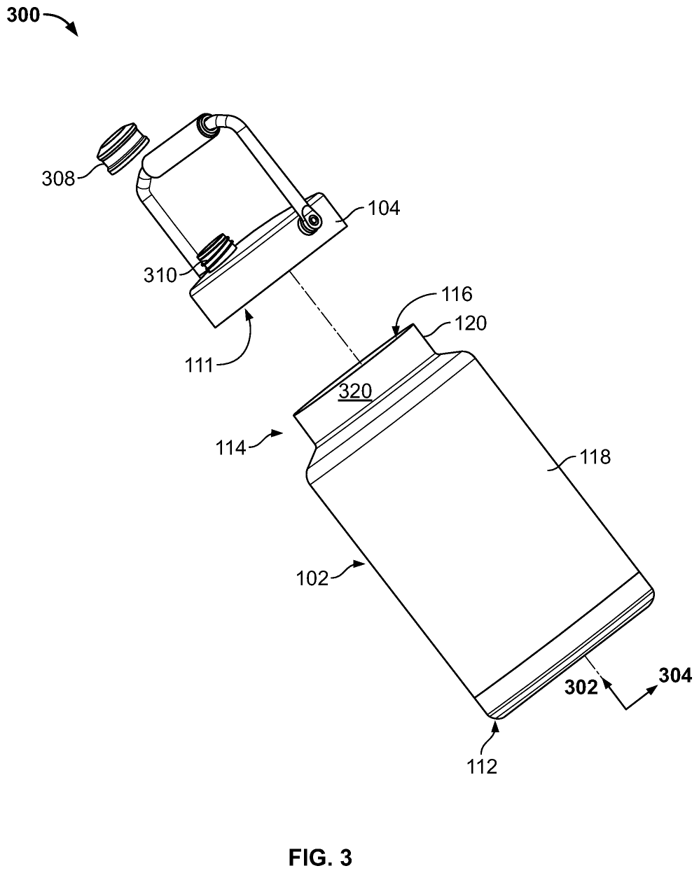

FIG. 1 depicts an isometric view of a container 100. In one example, container 100 may comprise a bottom portion 102 having a lid 104 removably coupled thereto. In one example, the bottom portion 102 may be substantially cylindrical in shape. In various examples, bottom portion 102 may be referred to as a canister 102, or base 102. The bottom portion 102 may, alternatively, be referred to as an insulated base structure having a substantially cylindrical shape, and having an opening 116 in one end 114 as shown in FIG. 3. In another example to that implementation depicted FIG. 1, the bottom portion 102 may be substantially cuboidal, or prismoidal (e.g. a pentagonal prism, hexagonal prism, heptagonal prism, among others) in shape. In one implementation, the lid 104 may comprise a carry handle structure 106.

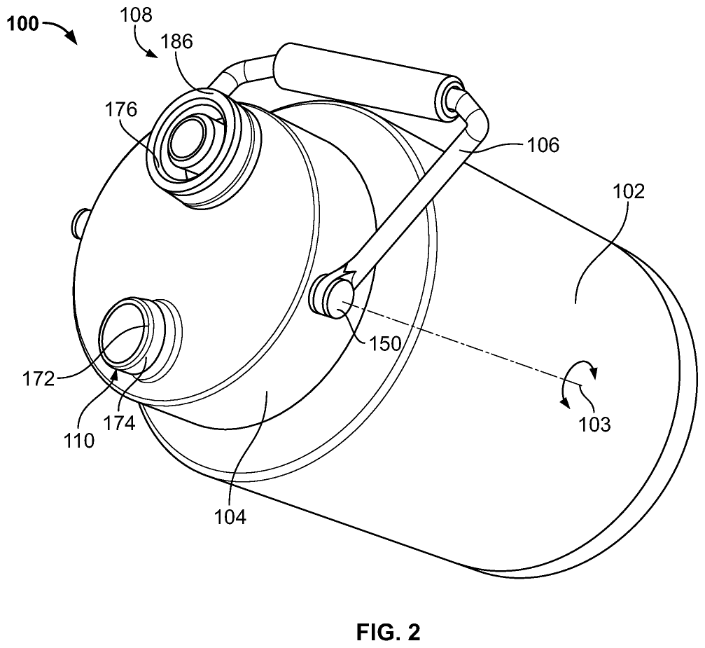

In various examples, the lid 104 may comprise a cap 108 (in one example, cap 108 may be substantially cylindrical), configured to removably couple to, and seal (i.e. resealably seal), a spout opening 110, as depicted in FIG. 2. In one implementation, the carry handle structure 106 may be rotatably coupled to the lid 104, such that the carry handle structure 106 may be pivoted from a first position, as depicted in FIG. 1, to a plurality of second positions, wherein one second position, from the plurality of second positions, is depicted in FIG. 2. For example, the carry handle structure 106 may be rotatable about an axis 103 through a fastener 150 that couples the carry handle structure 106 to the lid 104 (see FIG. 2). In one implementation, the carry handle structure 106 may be rotatable about axis 103 through an angle of greater than 320°. In another example, the carry handle structure 106 may be rotatable about axis 103 through an angle of greater than 300°, greater than 280°, greater than 260°, greater than 240°, or greater than 220°, among others.

In one example, the canister 102 may be configured to store a volume of liquid. In one implementation, the canister 102 may be configured to store approximately 1 gallon (approximately 3.79 L) of a liquid. In another implementation, the canister 102 may be configured to store at least approximately 30 ounces (approximately 0.89 L), at least approximately 50 ounces (approximately 1.48 L), at least approximately 70 ounces (approximately 2.07 L), at least approximately 80 ounces (approximately 2.37 L), at least approximately 90 ounces (approximately 2.66 L), at least approximately 100 ounces (approximately 2.96 L), at least approximately 110 ounces (approximately 3.25 L), or at least approximately 120 ounces (approximately 3.55 L) of a liquid, among others.

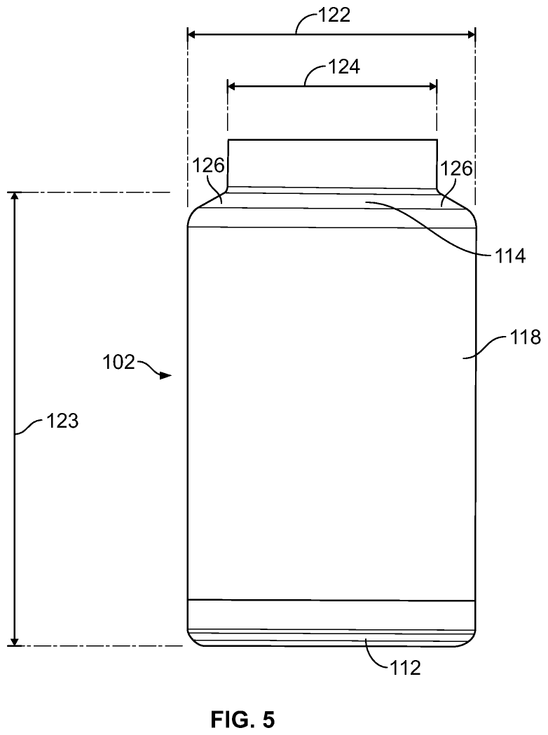

Turning briefly to FIG. 5, the canister 102 may have an outer diameter 122, and a height 123. In one implementation, the outer diameter 122 may measure approximately 6.5 inches (165.1 mm). In another implementation, the outer diameter 122 may measure approximately 5.7 inches (145 mm). In yet another implementation, the outer diameter 122 may range between 5 inches and 8 inches. In one example, the height 123 may measure approximately 9.7 inches (246.4 mm). In another implementation, the height 123 may measure approximately 7.4 inches (188 mm). In yet another implementation, the height 123 may range between 7 and 11 inches. However, in other implementations, the canister 102 may be embodied with different dimensional values for the outer diameter 122 and the height 123, without departing from the scope of this disclosure. Additionally, the canister 102 may maintain a same aspect ratio between the outer diameter 122 and the height 123 as that depicted in, for example, FIG. 5. However, in another implementation, the canister 102 may be embodied with dimensions such that a different aspect ratio between the outer diameter 122 and the height 123 to that depicted FIG. 5 may be utilized. In yet another implementation, canister 102 may be configured with any external or internal dimensions, and such that the canister 102 may be configured to store any volume of liquid, without departing from the scope of the disclosure described herein. Additionally or alternatively, the container 100 may be configured to store materials in a liquid, a solid, or a gaseous state, or combinations thereof, without departing from the scope of the disclosure described herein.

Turning again to FIG. 1, in various examples, the canister 102 may comprise a first end 112 forming a base configured to support the canister 102 on an external surface. In one example, for the implementation of container 100 having a substantially cylindrical bottom portion 102 (canister 102), the first end 112 may have a substantially circular shape. The canister 102 may comprise a second end 114 having an opening 116 therein, as depicted in FIG. 3. Further, the first end 112 and the second end 114 may be separated by a curved sidewall 118 forming a substantially cylindrical shape of the canister 102. In one implementation, the opening 116 may be configured to allow a liquid to be introduced into, or removed from the canister 102. In another example, when the lid 104 is coupled to the canister 102, the opening 116 may be configured to allow a liquid stored in the canister 102 to flow into the lid 104 and out through the spout 110.

In one example, the spout opening 110 may be configured with an annular ridge 172. As such, the cap 108 may be configured to be removably-coupled to the spout 110 using an interference fit between the annular ridge 172 on a cylindrical outer wall 174 of the spout opening 110, and a corresponding ridge (not pictured in FIG. 1 or FIG. 2) on an inner surface 176 of the cap 108, as depicted in FIG. 2.

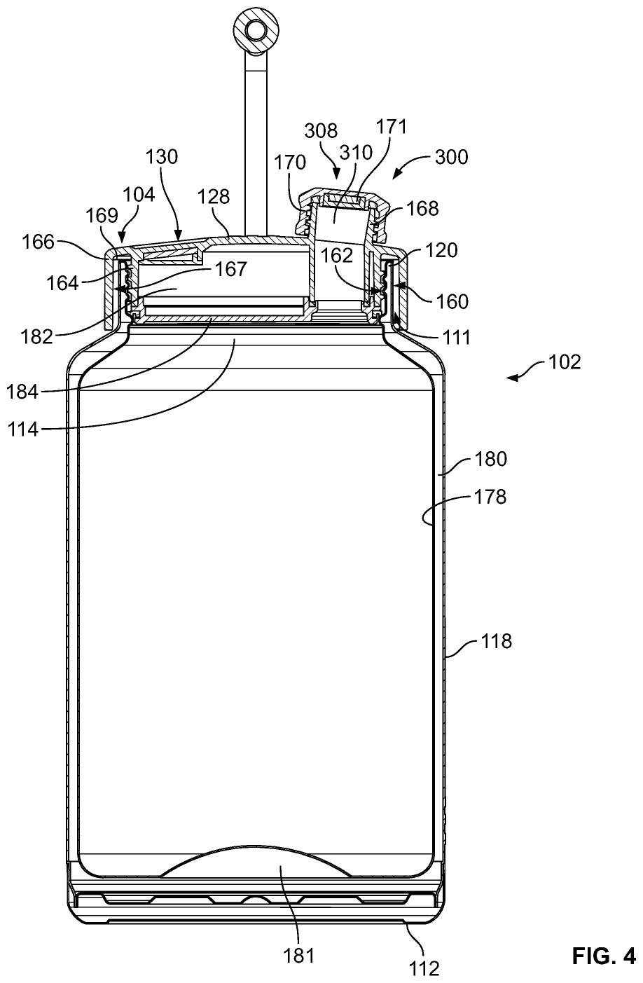

FIG. 3 depicts an exploded isometric view of another example container 300, according to one or more alternative aspects described herein. In one implementation, container 300 may be similar to container 100 from FIG. 1 and FIG. 2, where similar reference numerals represent similar features. In one example, container 300 may also comprise a lid 104 having a spout opening 310. However, the spout opening 310 may include a threaded outer wall 168 for receiving a correspondingly threaded inner wall of the cap 308. Specifically, as shown in FIGS. 3 and 4, the depicted cap 308 may be similar to the cap 108, but instead of utilizing an interference fit, the cap 308 may comprise a threaded inner wall 170 configured to be screwed onto a threaded cylindrical outer wall 168 of the spout opening 310.

In one example, the lid 104 may have a substantially cylindrical shape. In one implementation, the lid 104 may be configured to removably couple to a neck structure 120 of the canister 102. As such, the neck structure 120 may encircle the opening 116 in the canister 102, and extend out from the canister 102 in a substantially axial direction. In one implementation, an axial direction 302 associated with canister 102 may be parallel to an axis of rotation of a substantially cylindrical structure of canister 102, as depicted in FIG. 3. In one implementation, a radial direction 304 may be perpendicular to the axial direction 302. In various examples, lid 104 may have an opening 111 configured to receive the neck structure 120. Further details of a removable coupling between the lid 104 and the neck structure 120 are discussed in relation to FIG. 4.

In various examples, the canister 102 may be embodied with different geometries. For example, container 100 or container 300 may be embodied with a base portion, similar to canister 102, having a non-cylindrical shape. In particular, container 100 or container 300 may have a base, similar to canister 102, having a substantially cuboidal, spherical, or prismoidal shape, or combinations thereof, among others, without departing from the scope of the disclosures described herein. As such, container 100 or container 300 may have a base portion, similar to canister 102, having a non-cylindrical shape, but maintaining a substantially cylindrical neck structure 120, configured to be removably coupled to a substantially cylindrical lid 104. In yet another implementation, an opening, similar to opening 116, and a neck structure, similar to neck structure 120, may have non-circular geometries, without departing from the scope of the disclosures described herein. Additionally or alternatively, a lid of container 100 or container 300, similar to lid 104, may have a non-circular shape, without departing from the scope of the disclosures described herein. For example, a lid of container 100 or container 300, similar to lid 104, may have a substantially cuboidal, spherical, or prismoidal shape, or combinations thereof, among others, without departing from the scope of the disclosures described herein.

FIG. 4 depicts a cross-sectional view of one implementation of the container 300. In one example, the lid 104 may be removably coupled to the canister 102 using a threaded fastening mechanism. Accordingly, in one implementation, the neck structure 120 may have a smooth outer surface 160 and a threaded inner surface 162. In this way, the threaded inner surface 162 may be configured to interface with a threaded inner wall 164 of the lid 104. As such, when coupled to the canister 102, an outer wall 166 of the lid 104 may cover the neck structure 120.

Additional or alternative coupling mechanisms may be utilized to removably couple the lid 104 to the canister 102, without departing from the scope of the disclosures described herein. For example, the neck structure 120 may be embodied with a threaded outer surface (e.g. outer surface 320 may be threaded) and configured to interface with a corresponding threaded structure on the lid 104. In one example, this additional or alternative threaded structure on the lid 104 may be on an inside surface of the outer wall 166 (e.g. threads may be formed on inside surface 167 of the outer wall 166), among others.

In one example, a connection mechanism configured to removably couple the lid 104 to the canister 102 may be designed such that the coupling is fully engaged upon rotation of the lid 104 relative to the canister 102 by any number of revolutions, or by any fraction of a revolution. For example, the lid 104 may be fully engaged with the canister 102 upon placing the lid 104 on the neck structure 120, and rotating the lid 104 by approximately ¼ of one full revolution, approximately ⅓ of one full revolution, approximately ½ of one full revolution, approximately 1 full revolution, approximately 2 full revolutions, approximately 3 full revolutions, at least 1 revolution, or at least five revolutions, among many others.

In one implementation, a removable coupling between the lid 104 and the canister 102 may comprise one or more gaskets (e.g. gasket 169) configured to seal the coupling such that, in one example, liquid may not escape from the canister 102 while the removable coupling between the lid 104 and the canister 102 is engaged.

In one example the cap 308 may be fully engaged with the threaded fastening mechanism of the spout 310 by rotating the cap 308 relative to the spout 310 through an angle. For example, the cap 308 may be fully engaged with the spout 310 by rotating the cap 308 by approximately ¼ of one full revolution, approximately ⅓ of one full revolution, approximately ½ of one full revolution, approximately 1 full revolution, approximately 2 full revolutions, approximately 3 full revolutions, at least one revolution, or at least five revolutions, among many others.

In one implementation cap 108 (or cap 308) may seal the spout opening 110 (or spout opening 310) using one or more deformable gaskets structures that are compressed when the cap 108 (or cap 308) is brought into a removable coupling with the spout opening 110 (or spout opening 310). In one example, element 171 may be a gasket between the spout opening 310 and the cap 308.

In one implementation, containers 100 and 300 may include one or more insulating elements configured to reduce a rate of heat transfer to or from a material stored within the container. In one example, the canister 102 may be configured with a vacuum-sealed insulating structure, otherwise referred to as a vacuum-sealed double wall structure, or an insulated double wall structure, and such that a vacuum is maintained between an inner wall 178 and an outer wall 118 of the canister 102. In one implementation, a sealed vacuum cavity 180 may be sandwiched between the inner wall 178 and the outer wall 118. In other examples, specific implementations of insulating structures that utilize one or more vacuum chambers to reduce heat transfer by conduction, convection and/or radiation may be utilized within canister 102, without departing from the disclosures described herein. In another implementation, containers 100 and 300 may include an insulated double wall comprising an inner wall 178 and an outer wall 118. In one example, a cavity 180 between the inner wall 178 and the outer wall 118 may be filled with air to form an air pocket. In another example, the cavity 180 may be filled with an insulating material, such as an insulating foam (e.g. polystyrene).

In one example, the combination of the inner wall 178 and the outer wall 118 may be referred to as an insulated wall. In one implementation, the first end 112, the second end 114, the curved sidewall 118, and/or a shoulder region 126 (described in further detail in relation to FIG. 5) may comprise a vacuum-sealed insulated wall between the inner wall 178 and the outer wall 118. Further, an inner surface of one or more of the inner wall 178 or the outer wall 118 may comprise a silvered surface configured to reduce heat transfer by radiation.

In one implementation, canister 102 may comprise a concave structure 181 formed in the first end 112. In one example, the concave structure 181 may provide added rigidity to the first end 112, and such that the concave structure 181 reduces, or prevents, deformation of the first end 112 as a result of a vacuum within the vacuum cavity 180. Accordingly, the concave structure 181 may have any radius or multiple radii of curvature (i.e. the concave structure 181 may comprise a geometry having multiple radii of curvature), without departing from the scope of these disclosures.

In another implementation, the cavity 180 may be filled with an insulating material that exhibits low thermal conductivity. As such, the cavity 180 may, in one example, be filled with a polymer material, or a polymer foam material. In one specific example, the cavity 180 may be filled with polystyrene. However, additional or alternative insulating materials may be utilized to fill the cavity 180, without departing from the scope of these disclosures. In one example, a thickness of the cavity 180 may be embodied with any dimensional value, without departing from the scope of these disclosures

In one example, the canister 102 may be constructed from one or more metals, alloys, polymers, ceramics, or fiber-reinforced materials. Additionally, canister 102 may be constructed using one or more hot or cold working processes (e.g. stamping, casting, molding, drilling, grinding, forging, among others). In one implementation, the canister 102 may be constructed using a stainless steel. In one specific example, the canister 102 may be formed substantially of 304 stainless steel. In one implementation, one or more cold working processes utilized to form the geometry of the canister 102 may result in the canister 102 being magnetic (may be attracted to a magnet).

In one example, and as depicted in FIG. 4, the lid 104 may be embodied with a cavity 182. As such, this cavity 182 may be formed between the top surface 128 and a bottom surface 184. In this way, the cavity 182 may provide further insulation to the container 300 by containing one or more of an air pocket, a vacuum-sealed cavity, or by containing a mass of an insulating material, among others. In one specific example, the cavity 182 may be filled with a polymer foam, such as polystyrene. However, additional or alternative insulating materials may be utilized to fill the cavity 182, without departing from the scope of these disclosures.

FIG. 5 depicts an end view of canister 102, which may be used with container 100 or container 300. Accordingly, canister 102 may have a first outer diameter 122 at the first end 112 and a second outer diameter 124 at the opening 116 of the canister 102. In one example, the second diameter 124 may be less than the first diameter 122, such that an outer diameter of the substantially cylindrical sidewall 118 tapers from the first outer diameter 122 to the second outer diameter 124 along a shoulder region 126. In one example, the shoulder region 126 may improve heat transfer performance of the canister 102 (reduce a rate of heat transfer) when compared to a container having a constant outer diameter between a first end, similar to first end 112, and a second end, similar to the second and 114. In particular, the first end 112, the curved sidewall 118 (otherwise referred to as the outer wall 118), and the shoulder region 126 may comprise insulation having lower thermal conductivity (higher thermal resistance/insulation) than the lid 104 that seals the opening 116. As such, a configuration of container 100 or container 300 having opening 116 with a smaller second diameter 124 than the first diameter 122 provides for an increased surface area having the comparatively higher performance insulation (lower thermal conductivity insulation).

In another implementation, having the second outer diameter 124 less than the first outer diameter 122 may increase the structural rigidity of the canister 102 at the second end 114, and such that the opening 116 may be less prone to undesirable warping/bending during one or more processes used to form the structure of the canister 102.

In another example, the container 100 should not be limited to having a first diameter 122 greater than a second diameter 124 such that an outer diameter of the substantially cylindrical sidewall 118 tapers from said first outer diameter 122 to said second outer diameter 124 along a shoulder region 126. As such, the canister 102 may have a substantially constant outer diameter (not pictured), and such that an opening, similar to opening 116, may have a diameter approximately equal to an outer diameter of a first end of the base, similar to the first end 112.

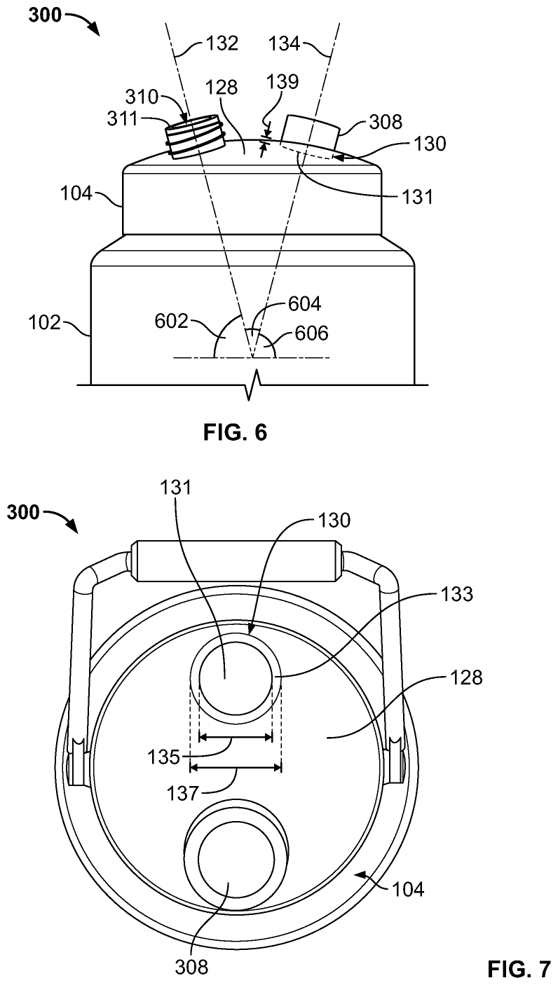

FIG. 6 schematically depicts an end view of container 300. In one implementation, the lid 104 may be configured with a circular domed (convex) top surface 128. In one implementation, the cap 308, when removed from the spout opening 310, may be positioned within a dimple 130, otherwise referred to as a recess structure 130 (depicted in the plan view of container 300 of FIG. 7). In one implementation, when positioned within the dimple 130, the cap 308 may be angled away from the spout 310, as schematically depicted in FIG. 6.

Additionally, FIG. 6 depicts the cap 308 removed from the spout 310 and positioned within the dimple 130. The spout 310 may have a central axis 132 corresponding to (parallel to) an axis of rotation associated with a substantially cylindrical structure of the spout opening 310. The central axis 132 may be perpendicular to an annular ridge 311 of the spout opening 310, similar to annular ridge 172 of the spout opening 110 from FIG. 2. In various examples, the dimple 130 may have a central axis 134 corresponding to (parallel to) an axis of rotation associated with a substantially circular structure of the dimple 130. The central axis 134 may be perpendicular to a planar surface 131 of the dimple 130.

In various examples, the spout 310 extends from the substantially convex geometry of the circular domed top surface 128 and has a central axis 132 which extends along a normal 132 relative to the domed top surface 128. The dimple 130 also includes a central axis 134 (which may be parallel to a central axis of cap 308, when positioned within dimple 130) and extends substantially along a normal 134 relative to the domed top surface 128, such that the spout 310 and the cap 308 may angled away from one another. Advantageously, and in various examples, this relative positioning of the spout 310 and the cap 308 may allow for improved separation, such that the cap 308 is not contacted when a user is drinking from/pouring from the spout 310.

In one implementation, an angle between central axis 132 (otherwise referred to as normal 132) and central axis 134 (otherwise referred to as normal 134) is schematically depicted as angle 604. As such, angle 604 may be referred to as an intersection angle 604 between a central axis 132 of the spout 310 and a central axis 134 of the dimple 130. As such, angle 604 may be greater than approximately: 2°, 5°, 10°, 15°, 20°, 30°, 45°, 55°, 60°, 70°, 80°, 90°, 100°, or 110°, among others. In another implementation, angle 604 may range from 2 to 110 degrees, among others. Angle 602 schematically represents an angle between central axis 132 (normal 132) and a base surface of the container 300 (e.g. first end 112). In one example, angle 602 may be referred to as a tilt angle 602 between the central access 132 and a base surface of the container 300 (e.g. first end 112, or any plane parallel thereto). In this way, tilt angle 602 may be an angle of less than 90°. As such, in various examples angle 602 may be less than approximately: 90°, 85°, 80°, 70°, 60°, 45°, or 30°, among others. In another implementation, angle 602 may range from 30 to 90 degrees, among others. Similar to angle 602, angle 606 schematically represents an angle between central axis 134 (normal 134) and a base surface of the container 300 (e.g. first end 112, or any plane parallel thereto). As such, angle 606 may be referred to as tilt angle 606. In this way, tilt angle 606 may be an angle of less than 90°. In various examples, angle 606 may be less than approximately: 90°, 85°, 80°, 70°, 60°, 45°, or 30°, among others. In one implementation, angle 606 may range from 30 to 90 degrees, among others. In one example, angle 602 may be approximately equal to angle 606. However, in other examples, angle 602 may not be equal to 606.

In one implementation, the circular domed top surface 128 may have a radius of curvature equal to approximately 13.5 inches (342 mm). However, in other implementations, any radius of curvature may be utilized to form the convex geometry of the circular domed top surface 128, without departing from the scope of these disclosures. Additionally or alternatively, the circular domed top surface 128 may comprise multiple radii of curvature, without departing from the scope of this disclosure.

In another implementation, the lid 104 may be configured with other top surface geometries than that circular domed top surface 128 depicted in FIG. 6. For example, lid 104 may have a substantially planar, or a substantially concave top surface, among others (not pictured). Furthermore, one or more of axes 132 and 134 may, in other implementations, not be normal to the circular domed top surface 128. In yet another implementation, axes 132 and 134 may be parallel to one another.

FIG. 7 schematically depicts a plan view of the container 300. In one implementation, the dimple 130 may have a substantially circular geometry. In particular, the dimple 130 may have a concave geometry. Accordingly, a concave geometry of dimple 130 may be embodied with any radius of curvature, without departing from the scope of these disclosures. In another example, the dimple 130 may have a flat bottom (i.e. substantially planar) surface 131 connected to the circular domed top surface 128 by a sidewall 133. In one example, the sidewall 133 may be straight, chamfered, or filleted. As such, in one implementation, the dimple 130 may have an inner diameter 135, an outer diameter 137, and a depth 139 (see FIG. 6). For that implementation of dimple 130 having a straight sidewall 133 between surface 131 and surface 128, the inner diameter 135 may be approximately equal to the outer diameter 137.

In one specific example, the inner diameter 135 may measure approximately 25.5 mm, and the outer diameter 137 may measure approximately 29.4 mm. In another example, the inner diameter 135 may measure up to approximately 28 mm, and the outer diameter 137 may measure up to approximately 30 mm. In other examples, the inner diameter 135 and the outer diameter 137 may be embodied with any dimensions, without departing from the scope of these disclosures. In one implementation, the depth 139 of the dimple 130 may range from 1 mm or less to 5 mm or more. However, the depth 139 may be embodied with any value, without departing from the scope of this disclosure. Further, the sidewall 133, if chamfered, may be angled at any angular value between the surface 131 and the surface 128. Similarly, the sidewall 133, if filleted, may have any radius of curvature between the surface 131 and the surface 128.

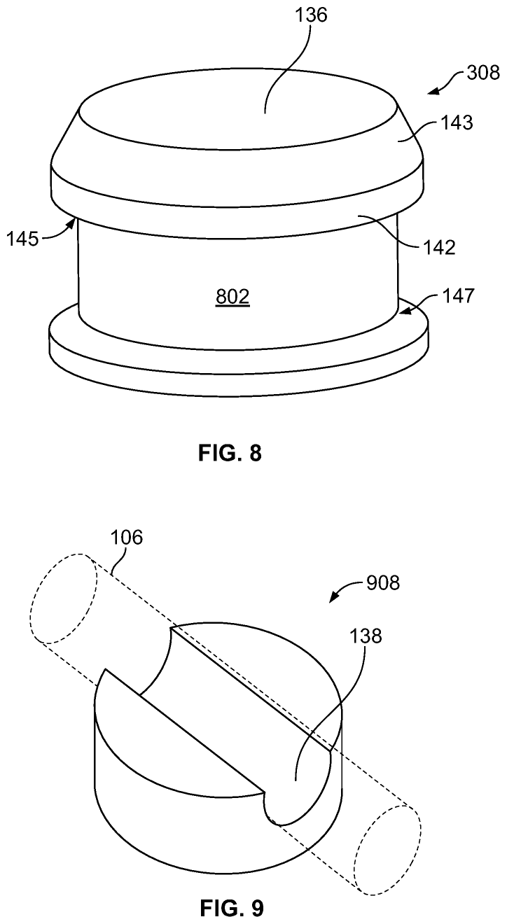

In one implementation, the magnetic surface 131 may comprise a polymer outer layer over a ferromagnetic structure (i.e. a metal plate may be positioned below magnetic surface 131 in order for the magnetic surface 131 to attract a magnet embedded within a magnetic top surface 136 of the cap 308 (see FIG. 8). In another implementation, the magnetic surface 131 may comprise a polymer overmolded over a magnet structure (i.e. a magnet may be positioned within the lid 104 as it is being molded.

The term “magnetic,” as utilized herein, may refer to a material (e.g. a ferromagnetic material) that may be magnetized. As such, the term “magnetic” may imply that a material (i.e. a surface, or object, and the like) may be magnetically attracted to a magnet (i.e. a temporary or permanent magnet) that has an associated magnetic field. In one example, a magnetic material may be magnetized (i.e. may form a permanent magnet). Additionally, various examples of magnetic materials may be utilized with the disclosures described herein, including nickel, iron, and cobalt, and alloys thereof, among others.

FIG. 8 depicts a more detailed view of the cap 308. In particular, cap 308 may be configured with a substantially cylindrical geometry. In one implementation, the cap 308 may comprise a magnetic top surface 136. As such, the cap 308 may be configured to removably couple to, and seal, the spout 310. Further, upon manual removal of the cap 308 from the spout 310, the magnetic top surface 136 may be configured to magnetically couple to a magnetic surface 131 of the dimple 130, as depicted in FIG. 7. As such, the dimple 130 may comprise a magnetic material to which the magnetic top surface 136 may be magnetically attracted.

In one example, the cap 308 may be constructed from a polymer material, and formed using one or more injection molding processes. As such, the magnetic top surface 136 may comprise an overmolded permanent magnet. Various permanent magnet materials may be utilized with the magnetic top surface 136 of cap 308, without departing from the scope of the disclosures described herein. In one particular example, the magnetic top surface 136 may comprise a neodymium magnet of grade N30, among others. Furthermore, various overmolding methodologies may be utilized to encapsulate a magnet within the cap 308, without departing from the scope of the disclosures described herein. In another example, the cap 308 may comprises a permanent magnet coupled below the polymeric magnetic top surface 136 such that the permanent magnet may be ultra-sonically welded, or glued onto a surface within the cap 308 (e.g. magnet 173 may be retained within the cap 308 by structure 175, which may comprise a polymer plate that is ultra-sonically welded, glued, or otherwise coupled to the cap 308.

Advantageously, a magnetic coupling between the magnetic top surface 136 of cap 308, and the magnetic surface 131 of dimple 130 may provide for fast, temporary storage of cap 308 while a liquid is being poured from container 300. In this way, a user may quickly affix cap 308 into dimple 130 such that cap 308 may not be set aside on an external surface where it may be misplaced or contaminated. Further advantageously, a magnetic coupling between the magnetic top surface 136 of the cap 308 and a magnetic surface 131 of the dimple 130 may encourage surfaces 136 and 131 to contact one another such that a bottom surface of cap 308 (e.g. bottom surface 186 of cap 108, which may be similar to 308) does not contact the magnetic surface 131 of the dimple 130. In this way one or more surfaces, including the bottom surface 186, of cap 108 or 308 may be exposed to fewer contaminants, and thereby reduce transmission of fewer contaminants to spout 310 upon re-coupling of the cap 308 with the spout 310. It is noted that the previously described advantages with regard to magnetically coupling the cap 308 into the dimple 130 may, additionally or alternatively, be realized with cap 108 from container 100.

In one example, cap 308 may comprise one or more polymer materials. However, cap 308 may comprise one or more of a metal, an alloy, a ceramic, or a wood material or combinations thereof, without departing from the scope of the disclosure described herein.

In one example, cap 308 may have a substantially cylindrical shape with a cylindrical outer wall 802. As such, cap 308 may be embodied with any outer diameter for the outer wall 802, without departing from the scope of this disclosure. In one example, cap 308 may have a surface 143 extending between the magnetic top surface 136 and a side surface 142. In one implementation, the surface 143 may form a chamfer between the top surface 136 and the side surface 142. As such, surface 143 may be embodied with any chamfer angle between the top surface 136 and the side surface 142. In another implementation, surface 143 may form a fillet between the top surface 136 on the side surface 142. As such, an example filleted surface 143 may be embodied with any desired fillet angle or radius. In one implementation, surface 143 may be utilized to center the cap 308 within the dimple 130. In one implementation, a fillet radius of surface 143 may be approximately equal to a fillet radius of surface (sidewall) 133 of the dimple 130. Similarly, and in another implementation, a chamfer angle of surface 143 may be approximately equal to a chamfer angle of surface (sidewall) 133 of dimple 130. In one example, the cap 308 may have lip structures 145 and/or 147 to facilitate manual gripping of the cap 308 to remove upon removal of the cap 308 from the spout 310 or the dimple 130, among others. In another implementation, the cap 308 may be implemented such that outer wall 802 has an outer diameter equal to the outer diameter of surface 142, and such that the cap 308 is not embodied with lip structures 145 and/or 147.

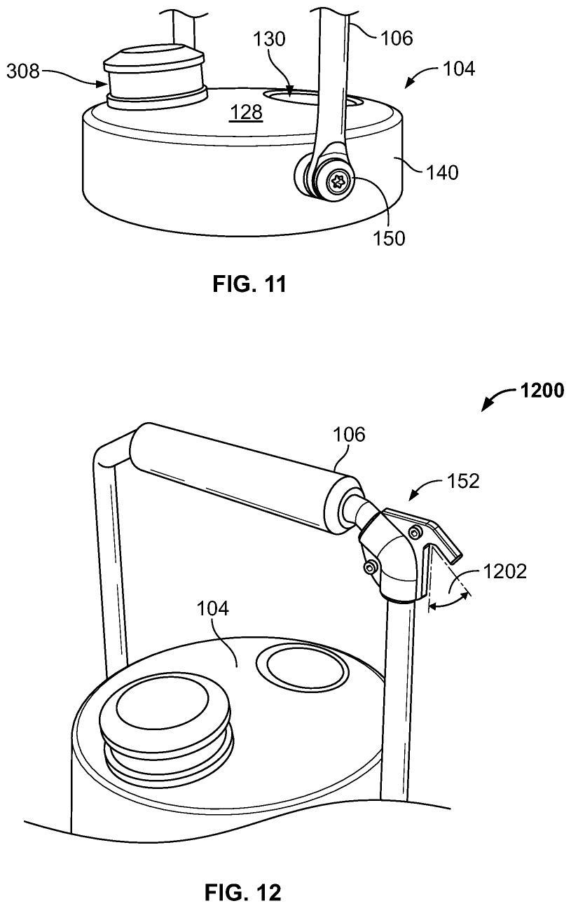

In one example, and as depicted in FIG. 11, the spout 310 (FIG. 11 depicts the cap 308 coupled to the spout 310) may be off-center on the circular domed top surface 128. In particular, the spout 310 may be positioned substantially at a perimeter of the circular domed top surface 128. Further, in one implementation, the recess 130 may be diametrically opposed to the spout opening 310, as depicted FIG. 7. However, the spout opening 310 may be positioned in other locations on the lid 104, without departing from the scope of the disclosure described herein. For example, the spout opening 310 may be positioned substantially at a center of the circular domed top surface 128. In another example, the spout opening 110 may be positioned on a curved sidewall of the lid 104, such as the curved sidewall 140 depicted in FIG. 11. In another example, the recess 130 may not be diametrically opposed to the spout opening 310. As such, in one example, the recess 130 may be positioned substantially at a center of the domed top surface 128, while the spout opening 310 may be positioned substantially at the perimeter of the circular domed top surface 128.

In one implementation, the lid 104, as depicted in FIG. 7, may be constructed from a polymeric material. In one example, the lid 104 may be injection molded. In one implementation, dimple 130 may comprise a ferromagnetic structure, or plate, that is overmolded to form the lid 104. In this way, upon manual removal of the cap 308 from the spout 310, the magnetic top surface 136 of the cap 308 may be magnetically attracted to the dimple structure 130 when positioned within a given proximity of the dimple structure 130. In another example, dimple 130 may comprise a ferromagnetic structure, or plate, that is positioned behind the surface 131 (e.g. glued, or ultra-sonically welded or otherwise attached to an interior side of the lid 104 within the cavity 182).

In one example a force needed to remove the cap 308 from the dimple structure 130 (i.e. a force to overcome a magnetic attraction between the cap 308 and the dimple structure 130) may measure approximately 10 N. In another example, the force to remove cap 308 from the dimple structure 130 may range between approximately 7 and 15 N. In another implementation, magnetic top surface 136 may be magnetically coupled to the curved sidewall 118 of the canister 102. Accordingly, in one example, a force needed to overcome a magnetic attraction between the cap 308 and the curved sidewall 118 may measure approximately 3 N. In another example, the force to remove the cap 308 from the curved sidewall 118 may range between approximately 1 and 10 N.

In another implementation, there may be a specific distance/proximity within which magnetic attraction is exerted between the magnetic top surface 136 of the cap 308, and the ferromagnetic structure of the dimple 130. This proximity may be dependent upon a strength (magnetic field strength, and the like) of the magnet contained within the magnetic top surface 136, among other factors. As such, there may exist a proximity within which the magnetic top surface 136 of the cap 308 may be positioned relative to the dimple structure 130 in order to magnetically couple the two structures may be embodied with any distance value. This proximity may be embodied with any value, without departing from the scope of the disclosures described herein. Accordingly, any strength of magnet may be utilized with the disclosures described herein. Additionally, various ferromagnetic materials may be utilized within the dimple structure 130, without departing from the disclosures described herein.

In another example, a ferromagnetic material may be positioned within the dimple structure 130, and such that an overmolding process is not utilized to cover the ferromagnetic material. Similarly, a magnet may be positioned on the magnetic top surface 136 of the cap 308, and such that the magnet is exposed, rather than being overmolded or covered.

In various examples, the container 300 may be configured such that the magnetic top surface 136 of the cap 308 is configured to magnetically couple only within the recess 130. As such, the remainder of container 300 may be constructed using one or more non-magnetic materials. In another example, a magnetic top surface 136 of the cap 308 may be configured to magnetically couple to one of a plurality of locations on the lid 104. In particular, in one example, the circular domed top surface 128 of the lid 104 may comprise a plurality of overmolded ferromagnetic pieces configured to magnetically couple to the magnetic top surface 136 of the cap 308. In another example, the lid 104 may be constructed using, or coated with, a metallic material that may be attracted to a magnetic field.

In various examples, container 300 may be configured such that the magnetic top surface 136 of the cap 308 may be configured to magnetically couple to the spout 310 (i.e. spout 310 may be embodied with one or more ferromagnetic materials). Accordingly, the opening into the canister 102 through the spout opening 310 may be sealed by magnetic attraction of the cap 308 to the spout opening 310.

In various examples, cap 308 may be attached within dimple 130 using another coupling mechanism in addition to, or as an alternative to, the magnetic metric coupling between the magnetic top surface 136 and surface 131. For example, the top surface 136 and surface 131 may be embodied with complementary threaded coupling elements, interference fit coupling elements (i.e. snap coupling), or hook and loop coupling elements, among others.

Additionally or alternatively, the canister 102 may comprise a magnetic material, such that the magnetic top surface 136 may be magnetically coupled to a surface (e.g. the curved sidewall 118) of the canister 102. In one particular example, the canister 102 may comprise a stainless steel material (e.g. 304 stainless steel), and may be magnetized by a one or more cold working processes used to form the various geometries of the canister 102. However, the canister 102, and indeed any of the structures of container 300 described herein, may be constructed using one or more of a metal, an alloy, a polymer, a ceramic, a wood material, or combinations thereof.

In various examples, the recess 130 may comprise an overmolded, or otherwise covered, permanent magnet, and the magnetic top surface 136 of the cap 308 may comprise an overmolded ferromagnetic material (e.g. iron). In yet another example, both of the magnetic top surface 136 and the recess structure 130 may comprise overmolded, or otherwise covered, permanent magnets configured to attract one another, and the like.

In one example, the cap 308 may comprise a substantially planar magnetic top surface 136. In this way, the substantially planar magnetic top surface 136 may be configured to interface with a substantially planar surface of the recess 130. In another example, a cap 308 may be configured with different geometries. For example, the cap 308 may comprise a curved top surface 136. In another example, FIG. 9 depicts a cap 908 having a magnetic channel structure 138 (rounded surface 138) configured to allow the cap 908 to be magnetically coupled to a curved surface. In one implementation, the magnetic channel structure 138 may be configured to magnetically couple to one or more curved surfaces of the carry handle structure 106. In this way, the carry handle structure 106 may be configured with one or more magnetic materials (overmolded, covered, or exposed magnetic materials). In one implementation, one or more portions of the carry handle structure 106 may comprise a magnet and such that one or more portions of the carry handle structure 106 may be magnetically attracted to, and held in position when brought into contact with, sidewall 118. In yet another example, the magnetic channel structure 138 may have a concave geometry configured to conform to a curved surface geometry of a curved sidewall 118 of the canister 102. As such, the magnetic channel structure 138 may comprise one or more overmolded, or otherwise covered, permanent magnet structures, similar to the magnetic top surface 136 of cap 308 depicted in FIG. 8.

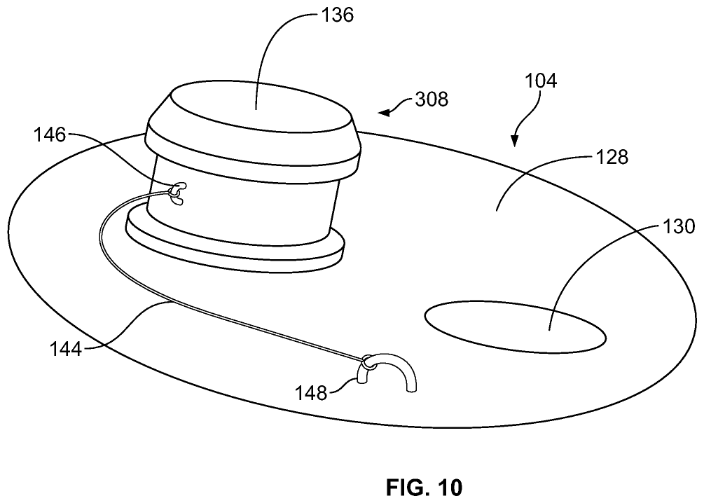

In one implementation, the cap 308 may be embodied with additional or alternative features. For example, and as depicted in FIG. 10, the cap 308 may be embodied with a tether 144 connected between a first anchor point 146 on the cap 308 and a second anchor point 148 on the lid 104. The first anchor point 146 and the second anchor point 148 can be in the form of U-shaped connectors that are either separately fastened or integrally molded. Advantageously, the tether 144 may be utilized to prevent separation of the cap 108 and the lid 104, and may be utilized in combination with a magnetic coupling between a magnetic top surface 136 and a recess 130, such that the magnetic coupling prevents the cap 108 from falling into a stream of liquid being poured from the spout 310, among others. As such, the tether 144 may comprise any flexible material, such as a polymer, a metal, or an alloy, among others, and may be embodied with any length. Similarly, the first anchor point 146 and the second anchor point 148 may be positioned at different locations on the cap 308 and the lid 104, respectively, without departing from the scope of the disclosures described herein.

FIG. 11 depicts a more detailed view of a hinged coupling between the carry handle structure 106 and the lid 104. In particular, a rotatable coupling between the carry handle structure 106 and the lid 104 may be facilitated by fastener 150. In one implementation, fastener 150 may act as a bearing about which the carry handle structure 106 may rotate relative to the lid 104. In one implementation, fastener 150 may comprise a screw configured to be received into a recess in the curved sidewall 140 of the lid 104. However, additional or alternative fastening mechanisms that may be utilized to hingedly couple the carry handle structure 106 to the lid 104, without departing from the scope of the disclosures described herein.

FIG. 12 depicts an implementation of a container 1200. Accordingly, container 1200 may be similar to containers 100 and 300, and may, additionally, be embodied with a hook structure 152 rigidly coupled to the carry handle structure 106. As such, the hook structure 152 may be configured to allow the container to be hung from an external structure (e.g. a chain-link fence, similar to fence 156 from FIG. 13, among many others). As depicted in FIG. 12, the hook structure 152 may be positioned at one side of the carry handle structure 106. However, alternative configurations for the hook structure 152 may be utilized without departing from the scope of the disclosures described herein. For example, container 1200 may be embodied with two or more hook structures (e.g. one hook structure to either side of the carry handle structure 106).

In one implementation, the hook structure 152 may be angled at an angle 1202. In one specific example, angle 1202 may range be range from approximately 20° to approximately 75°. However, additional or alternative implementations of the hook structure 152 may be utilized, including an angle 1202 outside of the range of 20° to 75°, without departing from the scope of these disclosures.

FIG. 13 depicts another example implementation of a container 1300. Accordingly, container 1300 may be similar to containers 100, 300, and 1200 where similar reference numerals represent similar components and features. In this example implementation, container 1300 may have a hook structure 154, which may be positioned as a center of a grip structure 158 of the carry handle structure 106, and such that the container 100 may be hung from a chain-link fence 156, among others. Accordingly, hook structure 152 and hook structure 154 may be constructed from one or more metals, alloys, or polymers, without parting from the scope of the disclosures described herein.

According to one aspect, an insulating container may have a canister that has an insulated double wall with a first end to support the canister on a surface, a second end, and a sidewall. The canister may also have an opening in the second end that extends through the insulated double wall. A neck structure may encircle the opening and extend in an axial direction. A lid may seal the opening by receiving the neck structure into a corresponding opening in the lid. The lid may further have a circular domed top surface having a spout opening, and a removable cap that seals the spout opening. Further, the cap may have a magnetic top surface configured to be magnetically attracted to, and retained within, a dimple on the domed top surface.

According to another aspect, a container may have a bottom portion with a first end, a second end having an opening, and a cylindrical wall spaced between the first and the second end. The bottom portion may taper from a first outer diameter at the first end, to a second, smaller outer diameter at the second end. The bottom portion may further have a neck structure around the opening. Additionally, the container may have a lid that seals the opening, the lid further having an opening to receive the neck structure. A top surface of the lid may have a spout opening, and a removable cylindrical cap that seals the spout opening. The removable cylindrical cap may have a magnetic top surface. Additionally, the top surface may have a recess with a magnetic surface that magnetically couples to the magnetic top surface of the cylindrical cap when removed from the spout.

In yet another aspect, a container may have an insulated base structure with a cylindrical shape and an opening in one end. The container may also have a lid with a bottom surface that seals the insulated base structure. A top surface of the lid may have a spout, and a cap that removably couples to, and seals, the spout. The cap may have a magnetic top surface. Additionally, the lid may have at least one ferromagnetic piece, and a carry handle. Further, a tilt angle between a central axis of the spout and the bottom surface of the lid may be less than 90°.

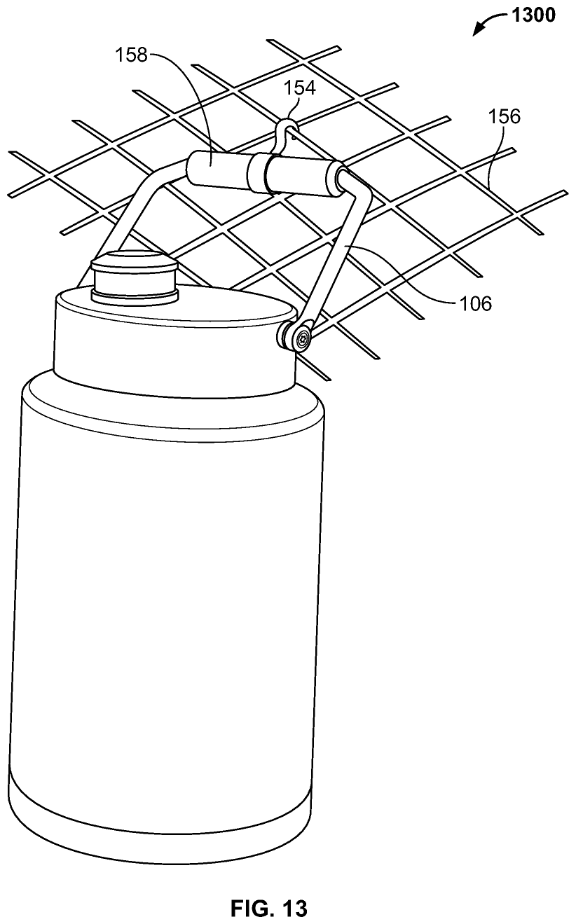

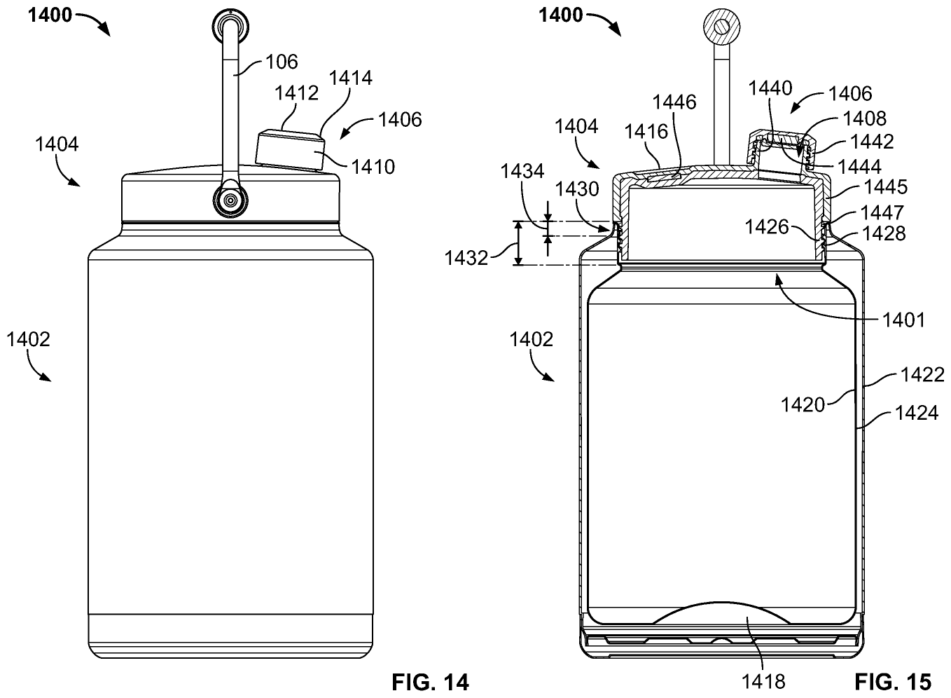

FIG. 14 depicts another implementation of a container 1400, according to one or more aspects described herein. In one example, container 1400 may comprise a bottom portion 1402 having a lid 1404 removably-coupled thereto. Further, the bottom portion 1402 may be referred to as a canister, base, or insulated base structure that has a substantially cylindrical shape, among others. Carry handle 106 may be rotatably-coupled to the lid 1404. Additionally, the lid 1404 may comprise a cap 1406 that is configured to removably-coupled to, and resealably seal a spout opening 1408 (as depicted in FIG. 15) of the lid 1404.

In various examples, the cap 1406 may have a substantially cylindrical side wall 1410 separated from a substantially circular magnetic top surface 1412 by a chamfered surface 1414, as depicted in FIG. 14. Accordingly, the chamfered surface 1414 may be similar to surface 143, as depicted FIG. 8. As such, the chamfered surface 1414 may be configured to center the magnetic top surface 1412 of the cap 1406 within the dimple/depression 1416 (as depicted in FIG. 15). In this way, the dimple 1416 may have complementary geometry configured to receive the magnetic top surface 1412 and chamfered surface 1414 of cap 1406.

FIG. 15 depicts a cross-sectional view of container 1400. Accordingly, the bottom portion 1402 may comprise a concave structure 1418, similar to concave structure 181 of bottom portion 102. Further, the bottom portion 1402 may have an insulated double wall structure comprising an inner wall 1420 and an outer wall 1422. As such, a sealed vacuum cavity 1424, similar to vacuum cavity 180, may be positioned between the inner wall 1420 and the outer wall 1422. In other implementations, the cavity 1424 may be filled with one or more insulating materials.

In one implementation, the lid 1404 is configured to resealably seal an opening 1401 in the bottom portion 1402. Accordingly, a threaded wall 1426 of the lid 1404 may be received by a threaded sidewall 1428 of the bottom portion 1402 to removably-couple the lid 1404 to the bottom portion 1402.

In various implementations, the bottom portion 1402 may have a neck structure 1430, and such that the threaded sidewall 1426 extends into the bottom portion 1402 to a depth 1432, greater than a height 1434 of the neck structure 1430. As such, the threaded sidewall 1428 may be configured to receive the threaded sidewall 1426 such that the neck structure 1430 abuts/is positioned proximate an outer wall 1445 of the lid 1404 at end 1447.

The spout opening 1408 may be embodied with a threaded sidewall 1440 configured to receive a threaded sidewall 1442 of cap 1406 to removably-couple the cap 1406 to the lid 1404.

A magnetic material 1444, such as, among others, a ferromagnetic plate that is not magnetized, or a permanent magnet, may be positioned below the magnetic top surface 1412 of the cap 1406. In this way, magnetic material 1444 may be similar to magnet 173 from FIG. 4. Similarly, a magnetic material 1446 may be positioned below the dimple 1416. As such, dimple 1416 may be similar to dimple 130.

In addition to the various elements described in relation to container 1400 and depicted in FIG. 14 and FIG. 15, container 1400 may comprise one or more additional or alternative elements described in relation to containers 100 or 300, without departing from the scope of these disclosures.

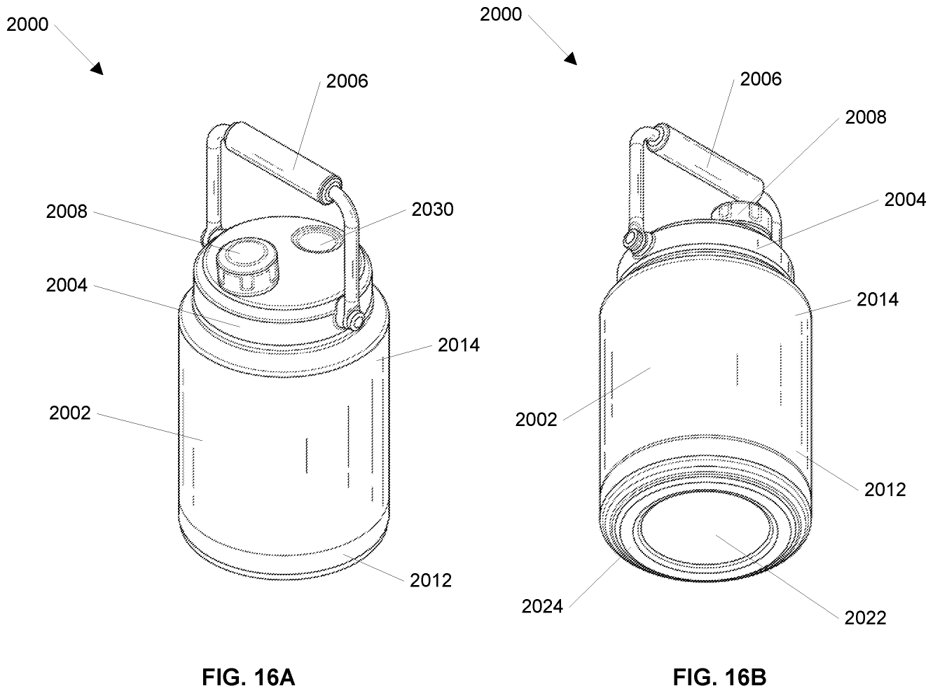

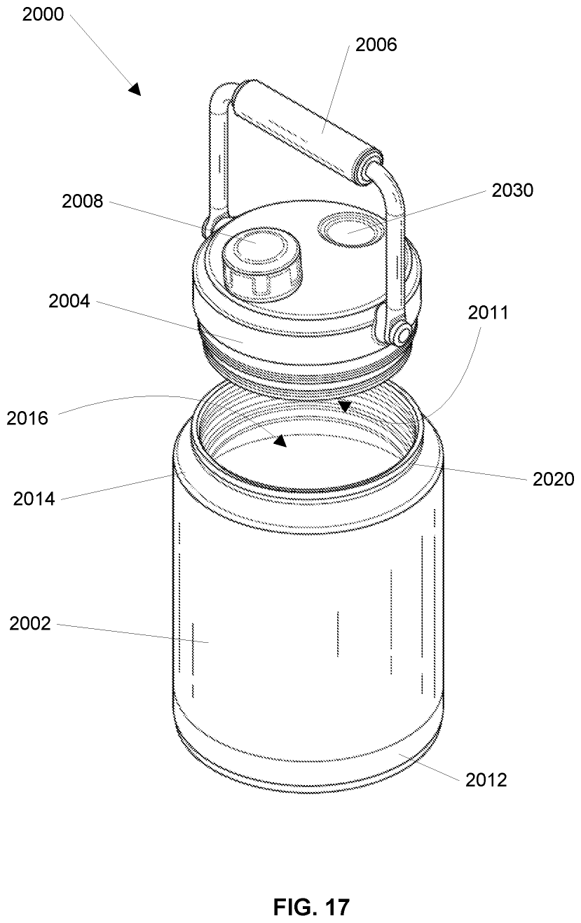

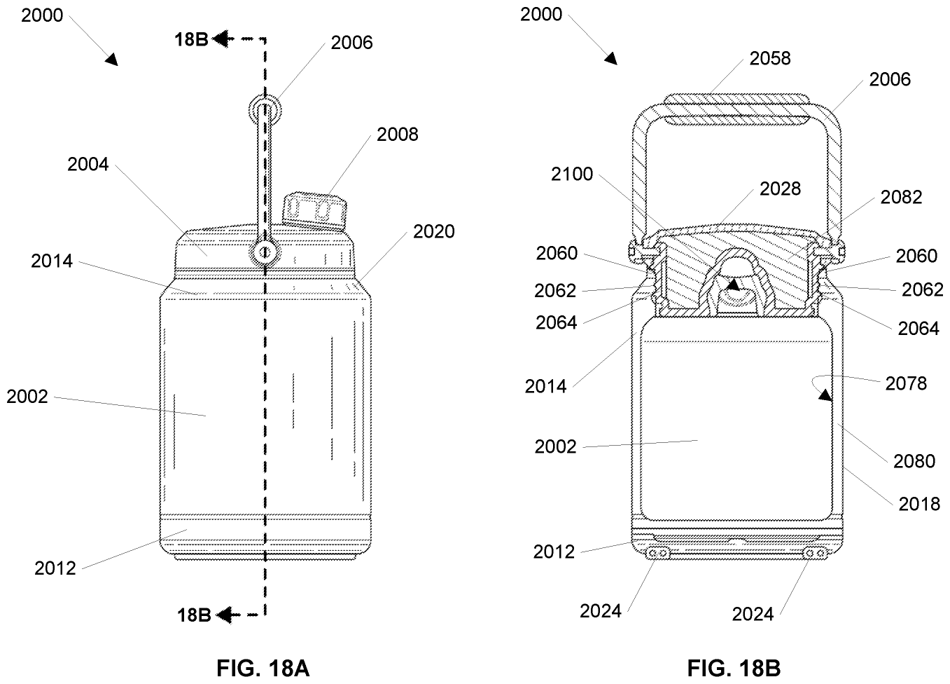

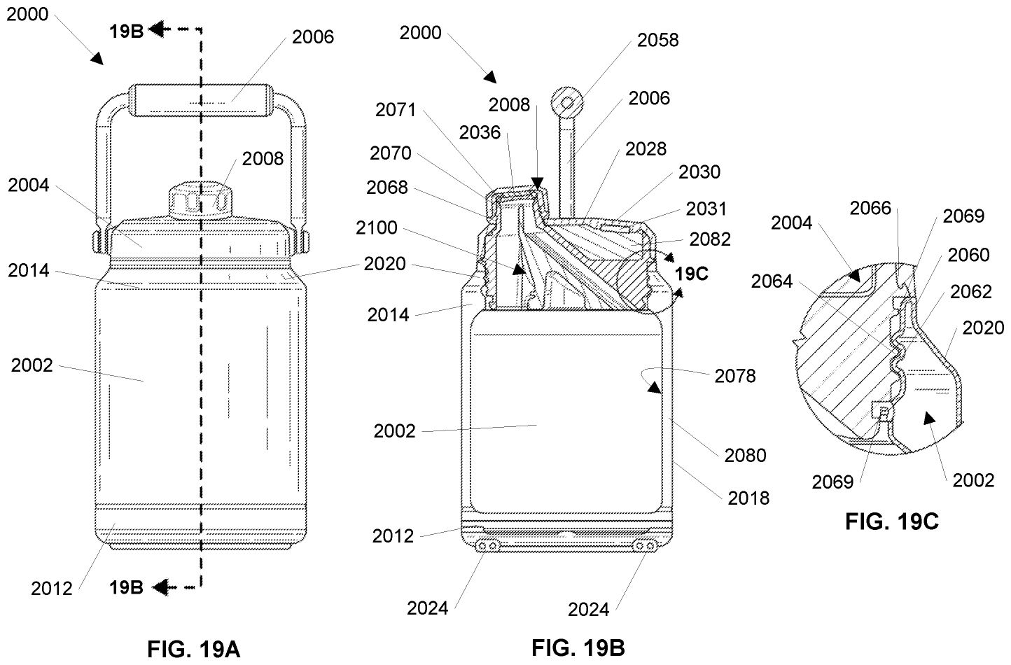

FIGS. 16A-38C depict another implementation of a container 2000, according to one or more aspects described herein. In one example, the container 2000 and lid assembly may include an integrated anti-glug venting feature within a removable cap. The container 2000 may also include a spring-ball detent for handle indexing. The container 2000 may also include features for helping the user hold the container, such as a base bumper and/or grip ring. FIGS. 16A and 16B depict isometric views of the container 2000. FIG. 17 depicts an exploded view of the container 2000. FIGS. 18A and 19A depict side views of the container 2000. FIG. 18B depicts a cross-section view along 18B-18B from FIG. 18A. FIG. 19B depicts a cross-section view along 19B-19B from FIG. 19A. In one example, container 2000 may comprise a canister 2002 having a lid assembly 2004 removably-coupled thereto. Further, the canister 2002 may be referred to as a bottom portion, base, or insulated base structure that has a substantially cylindrical shape, among others. Carry handle 2006 may be rotatably-coupled to the lid assembly 2004. In another embodiment, the carry handle 2006 may be rotatably-coupled to the cannister 2002. Additionally, the lid assembly 2004 may comprise a cap 2008 that is configured to removably-couple to, and resealably seal a spout 2010 of the lid assembly 2004.

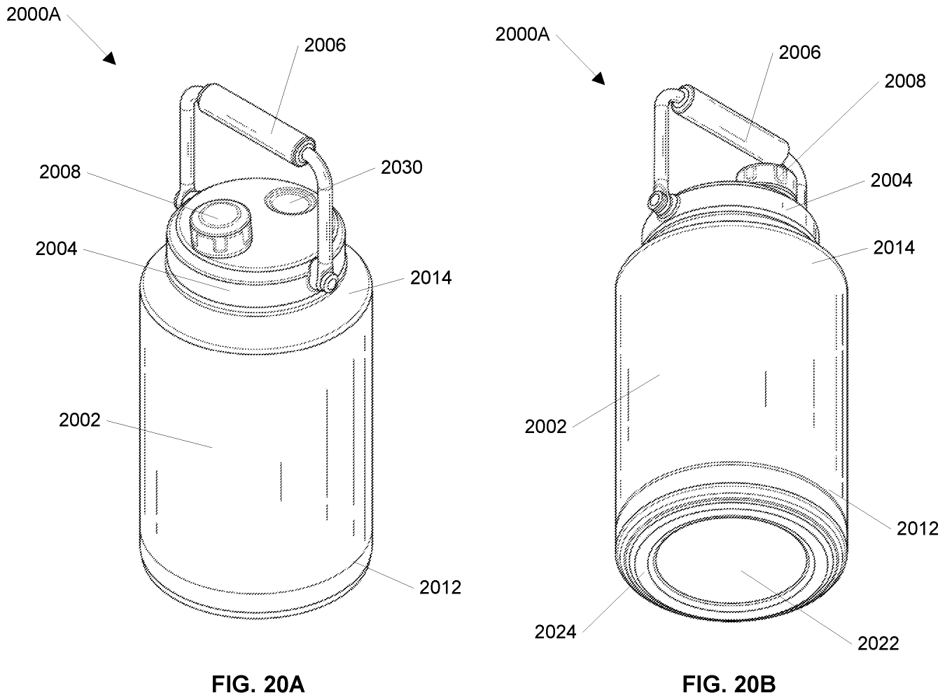

In one example, the canister 2002 may be configured to store a volume of liquid. In one implementation, the canister 2002 may be configured to store approximately 1 gallon (approximately 3.79 L) of a liquid. In another implementation, the canister 2002 may be configured to store at least approximately 30 ounces (approximately 0.89 L), at least approximately 50 ounces (approximately 1.48 L), at least approximately 70 ounces (approximately 2.07 L), at least approximately 80 ounces (approximately 2.37 L), at least approximately 90 ounces (approximately 2.66 L), at least approximately 100 ounces (approximately 2.96 L), at least approximately 110 ounces (approximately 3.25 L), or at least approximately 120 ounces (approximately 3.55 L) of a liquid, among others. FIGS. 20A and 20B depict a second container 2000A with a second canister 2002A that may be configured to store a different volume of liquid from the container 2000 and canister 2002. For example, the container 2000 and canister 2002 may be configured to store approximately 1/2 gallon (approximately 1.89 L) of a liquid and the second container 2000A and the second canister 2002A may be configured to store approximately 1 gallon (approximately 3.79 L) of liquid.

Turning again to FIGS. 16A and 16B, in various examples, the canister 2002 may comprise a first end 2012 forming a base configured to support the canister 2002 on an external surface. In one example, for the implementation of container 2000 having a substantially cylindrical bottom portion 2002 (canister 2002), the first end 2012 may have a substantially circular shape. The canister 2002 may comprise a second end 2014 having an opening 2016 therein, as depicted in FIG. 17. Further, the first end 2012 and the second end 2014 may be separated by a curved sidewall 2018 forming a substantially cylindrical shape of the canister 2002. In another example to that implementation depicted FIGS. 16A and 16B, the canister 2002 may be substantially cuboidal, or prismoidal (e.g. a pentagonal prism, hexagonal prism, heptagonal prism, among others) in shape. In one implementation, the opening 2016 may be configured to allow a liquid to be introduced into, or removed from the canister 2002.

In another example, when the lid assembly 2004 is coupled to the canister 2002, the opening 2016 may be configured to allow a liquid stored in the canister 2002 to flow into the lid assembly 2004 and out through the spout 2010. The spout 2010 may include a threaded outer wall 2068 for receiving a correspondingly threaded inner wall 2070 of the cap 2008. Specifically, as shown in FIG. 19B, the cap 2008 may comprise a threaded inner wall 2070 configured to be screwed onto a threaded cylindrical outer wall 2068 of the spout 2010. In another example, the spout 2010 may be configured with an annular ridge. As such, the cap 2008 may be configured to be removably-coupled to the spout 2010 using an interference fit between the annular ridge on a cylindrical outer wall of the spout 2010, and a corresponding ridge on an inner surface of the cap 2008.

FIGS. 18B and 19B depict cross-sectional views of one implementation of the container 2000. In one example, the lid assembly 2004 may be removably coupled to the canister 2002 using a threaded fastening mechanism. Accordingly, in one implementation, the neck structure 2020 may have a smooth outer surface 2060 and a threaded inner surface 2062. In this way, the threaded inner surface 2062 may be configured to interface with a threaded inner wall 2064 of the lid assembly 2004. As such, when coupled to the canister 2002, an outer wall 2066 of the lid assembly 2004 may cover the neck structure 2020. The neck structure 2020 of the canister 2002, as depicted in FIGS. 18A, 19A, and 21, may include a shoulder chamfer located between the curved sidewall 2018 and the smooth outer surface 2060.

In one example, and as depicted in FIGS. 18B and 19B, the lid assembly 2004 may be embodied with a cavity 2082. As such, this cavity 2082 may be formed between the top surface 2028 and a bottom surface 2084. In this way, the cavity 2082 may provide further insulation to the container 2000 by containing one or more of an air pocket, a vacuum-sealed cavity, or by containing a mass of an insulating material, among others. In one specific example, the cavity 2082 may be filled with a polymer foam, such as polystyrene. However, additional or alternative insulating materials may be utilized to fill the cavity 2082, without departing from the scope of these disclosures.

Additional or alternative coupling mechanisms may be utilized to removably couple the lid assembly 2004 to the canister 2002, without departing from the scope of the disclosures described herein. For example, the neck structure 2020 may be embodied with a threaded outer surface (e.g. outer surface 2060 may be threaded) and configured to interface with a corresponding threaded structure on the lid assembly 2004. In one example, this additional or alternative threaded structure on the lid assembly 2004 may be on an inside surface of the outer wall 2066 (e.g. threads may be formed on inside surface of the outer wall 2066), among others.

In one example, a connection mechanism configured to removably couple the lid assembly 2004 to the canister 2002 may be designed such that the coupling is fully engaged upon rotation of the lid assembly 2004 relative to the canister 2002 by any number of revolutions, or by any fraction of a revolution. For example, the lid assembly 2004 may be fully engaged with the canister 2002 upon placing the lid assembly 2004 on the neck structure 2020, and rotating the lid assembly 2004 by approximately ¼ of one full revolution, approximately ⅓ of one full revolution, approximately ½ of one full revolution, approximately one full revolution, approximately two full revolutions, approximately three full revolutions, at least one revolution, or at least five revolutions, among many others.

In one implementation, a removable coupling between the lid assembly 2004 and the canister 2002 may comprise one or more gaskets (e.g. gasket 2069) configured to seal the coupling such that, in one example, liquid may not escape from the canister 2002 while the removable coupling between the lid assembly 2004 and the canister 2002 is engaged.

In one example the cap 2008 may be fully engaged with the threaded fastening mechanism of the spout 2010 by rotating the cap 2008 relative to the spout 2010 through an angle. For example, the cap 2008 may be fully engaged with the spout 2010 by rotating the cap 2008 by approximately ¼ of one full revolution, approximately ⅓ of one full revolution, approximately ½ of one full revolution, approximately one full revolution, approximately two full revolutions, approximately three full revolutions, at least one revolution, or at least five revolutions, among many others.

In one implementation cap 2008 may seal the spout 2010 using one or more deformable gaskets structures that are compressed when the cap 2008 is brought into a removable coupling with the spout 2010. In one example, element 2071 may be a gasket between the spout 2010 and the cap 2008.

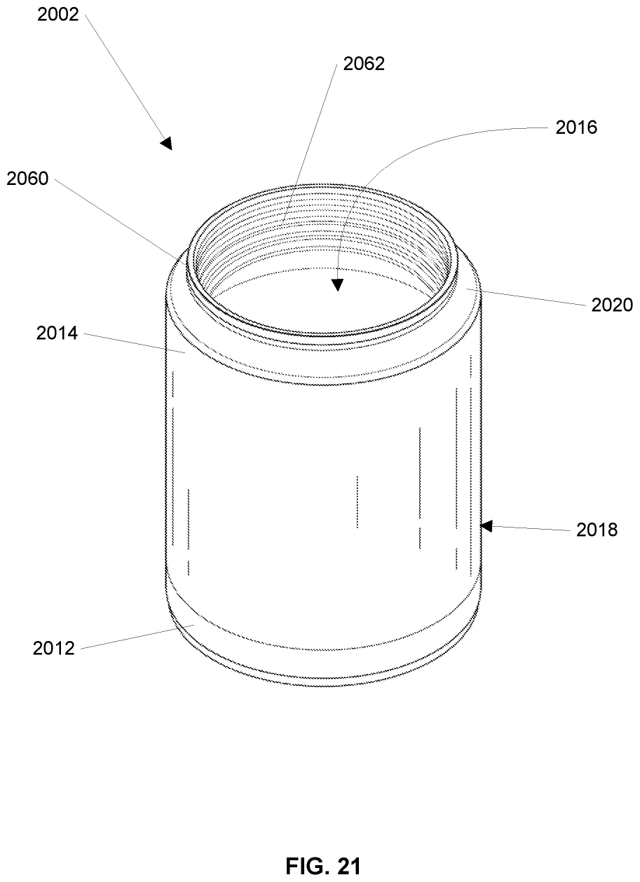

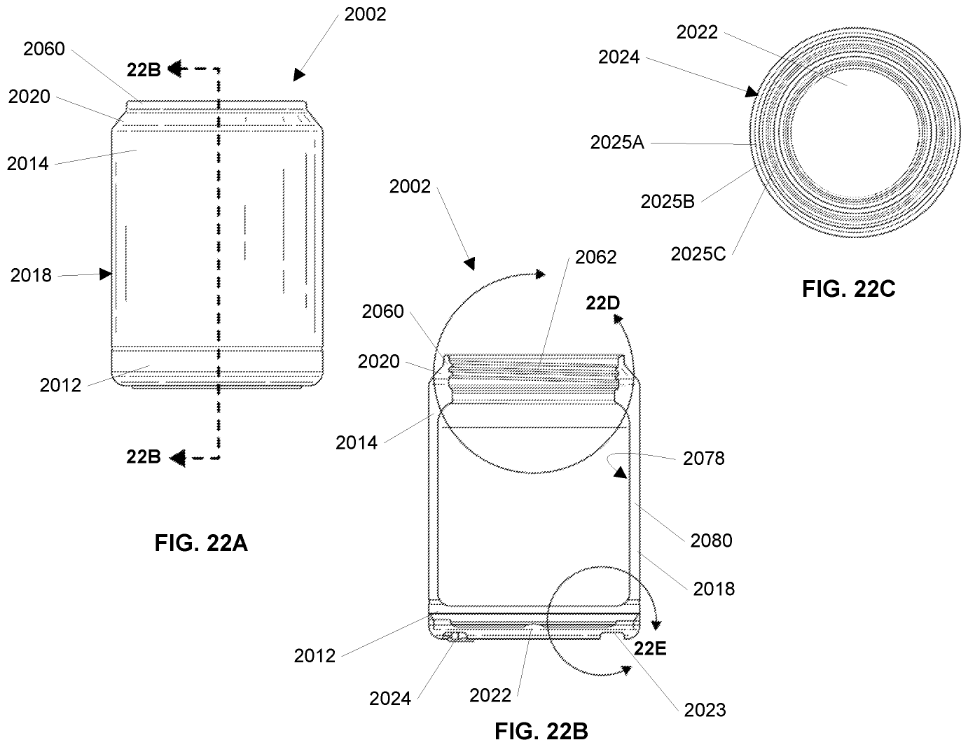

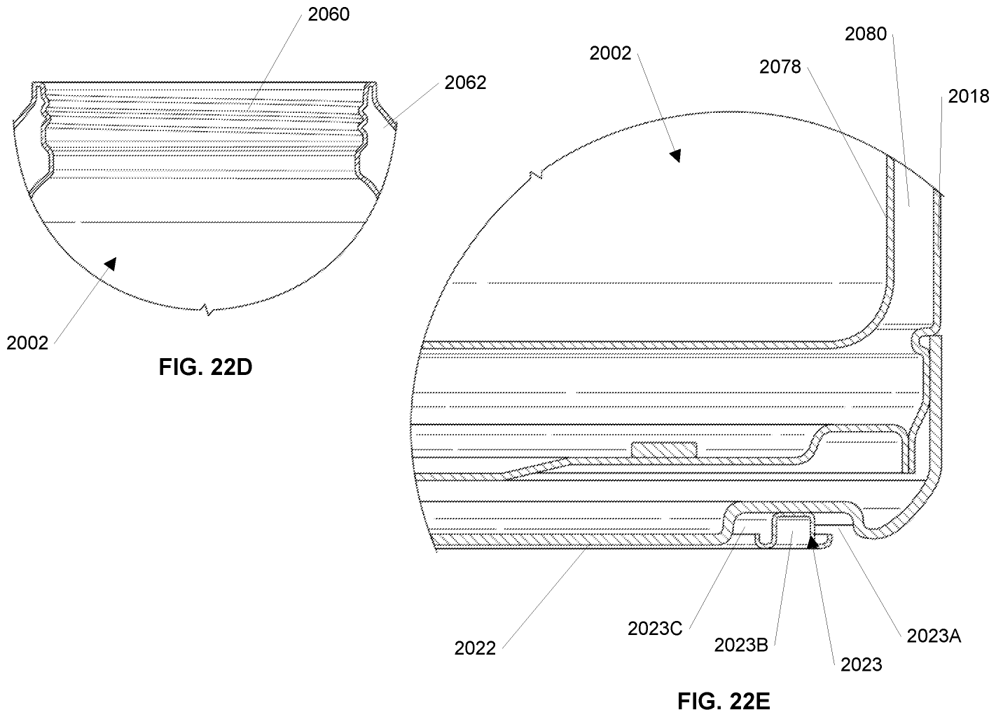

FIGS. 21-24C depict various views and various portions of the canister 2002. FIG. 21 depicts a top perspective view of the canister 2002. FIG. 22A depicts a side view of the canister 2002. FIG. 22B depicts a cross-section view along 22B-22B from FIG. 22A. FIG. 22C depicts a bottom view of the canister 2002. FIG. 22D depicts a close-up view of the top portion labeled 22D of the canister 2002 from FIG. 22B. FIG. 22E depicts a close-up view of the bottom portion labeled 22E of the canister 2002 from FIG. 22B.

In one implementation, the container 2000 may include one or more insulating elements configured to reduce a rate of heat transfer to or from a material stored within the container. In one example, the canister 2002 may be configured with a vacuum-sealed insulating structure, otherwise referred to as a vacuum-sealed double wall structure, or an insulated double wall structure, and such that a vacuum is maintained between an inner wall 2078 and an outer wall 2018 of the canister 2002. In one implementation, a sealed vacuum cavity 2080 may be sandwiched between the inner wall 2078 and the outer wall 2018. In other examples, specific implementations of insulating structures that utilize one or more vacuum chambers to reduce heat transfer by conduction, convection and/or radiation may be utilized within canister 2002, without departing from the disclosures described herein. In another implementation, the container 2000 may include an insulated double wall comprising an inner wall 2078 and an outer wall 2018. In one example, a cavity 2080 between the inner wall 2078 and the outer wall 2018 may be filled with air to form an air pocket. In another example, the cavity 2080 may be filled with an insulating material, such as an insulating foam (e.g. polystyrene).

In one example, the combination of the inner wall 2078 and the outer wall 2018 may be referred to as an insulated wall. In one implementation, the first end 2012, the second end 2014, the curved sidewall 2018, and/or the neck structure 2020 may comprise a vacuum-sealed insulated wall between the inner wall 2078 and the outer wall 2018. Further, an inner surface of one or more of the inner wall 2078 or the outer wall 2018 may comprise a silvered surface configured to reduce heat transfer by radiation.

In one implementation, canister 2002 may comprise a concave structure formed in the first end 2012. In one example, the concave structure may provide added rigidity to the first end 2012, and such that the concave structure reduces, or prevents, deformation of the first end 2012 as a result of a vacuum within the vacuum cavity 2080. Accordingly, the concave structure may have any radius or multiple radii of curvature (i.e. the concave structure may comprise a geometry having multiple radii of curvature), without departing from the scope of these disclosures.

In another implementation, the cavity 2080 may be filled with an insulating material that exhibits low thermal conductivity. As such, the cavity 2080 may, in one example, be filled with a polymer material, or a polymer foam material. In one specific example, the cavity 2080 may be filled with polystyrene. However, additional or alternative insulating materials may be utilized to fill the cavity 2080, without departing from the scope of these disclosures. In one example, a thickness of the cavity 2080 may be embodied with any dimensional value, without departing from the scope of these disclosures

In one example, the canister 2002 may be constructed from one or more metals, alloys, polymers, ceramics, or fiber-reinforced materials. Additionally, canister 2002 may be constructed using one or more hot or cold working processes (e.g. stamping, casting, molding, drilling, grinding, forging, among others). In one implementation, the canister 2002 may be constructed using a stainless steel. In one specific example, the canister 2002 may be formed substantially of 304 stainless steel. In one implementation, one or more cold working processes utilized to form the geometry of the canister 2002 may result in the canister 2002 being magnetic (may be attracted to a magnet).

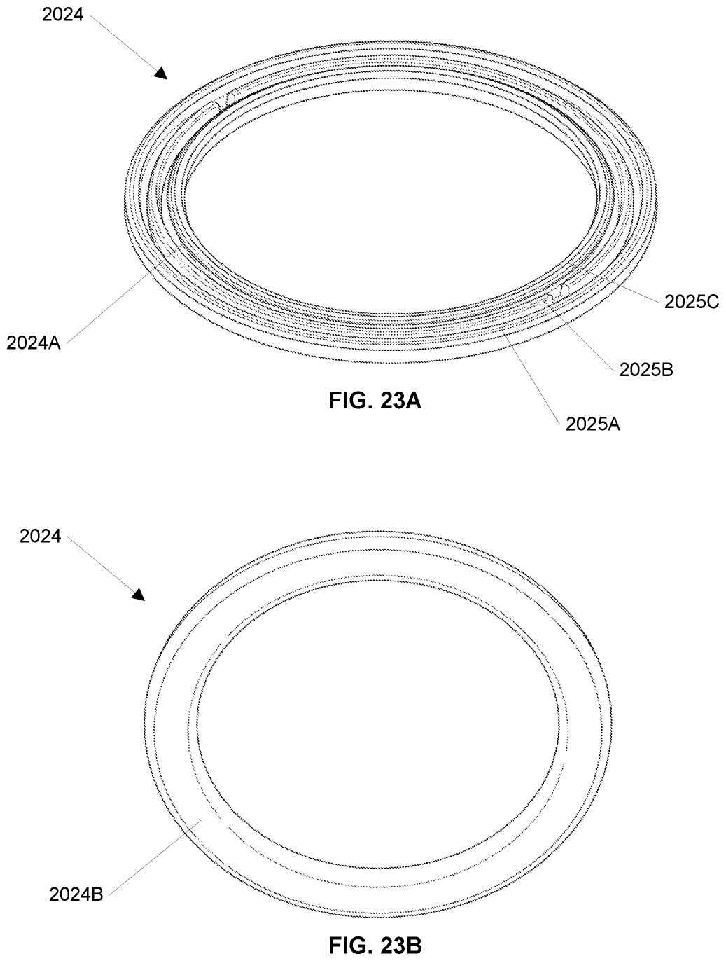

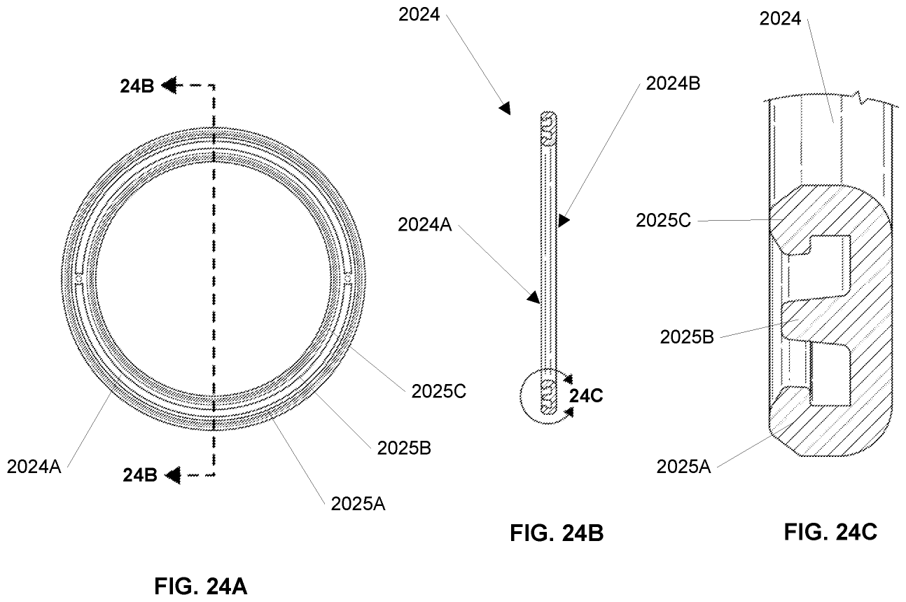

In one implementation, the canister 2002 may include features to help the user pour the canister 2002. In one example, as depicted in FIGS. 22B, 22C, 22E, 23A, 23B, 24A, 24B, and 24C, the canister 2002 and first end 2012 may include a base bumper 2024. FIG. 23A depicts a top perspective view of the base bumper 2024. FIG. 23B depicts a bottom perspective view of the base bumper 2024. FIG. 24A depicts a top view of the base bumper 2024. FIG. 24B depicts a cross-section view of the base bumper 2024 along 24B-24B from FIG. 24A. FIG. 24C depicts a close-up view of the area labeled 24C of the base bumper 2024 from FIG. 24B.

The canister 2002 and the first end 2012 may include a base 2022 with the base bumper 2024 fit within the base 2022. Specifically, the base bumper 2024 may fit within a circular base slot 2023 located on the base 2022. The circular base slot 2023 may circumferentially extend around the base 2022. The base bumper 2024 may add friction to the base 2022 when opening and closing the lid 2004 or cap 2008 on a slick surface. The base bumper 2024 may be made of a rubber or plastic-type material, or any other suitable material without departing from the scope of these disclosures.

As depicted in FIG. 22E, in one example, the circular base slot 2023 may include a first slot 2023A and a second slot 2023B separated by a slot member 2023C. The circular base slot 2023 with the first slot 2023A, the second slot 2023B, and the slot member 2023C are sized and shaped to fit a W-shaped base bumper 2024. As depicted in FIGS. 23A, 23B, 24A, 24B, and 24C, the base bumper 2024 may include a first side 2024A and a second side 2024B opposite the first side 2024A. The first side 2024A may include a W-shape and/or other ridges to provide an interference fit to cooperate with the circular base slot 2023. The base bumper 2024 may include a first arm 2025A, a second arm 2025B, and a third arm 2025C. The first arm 2025A may be sized and shaped to cooperate with the first slot 2023A of the circular base slot 2023 on the container 2002.

The second arm 2025B may be sized and shaped to cooperate with the second slot 2023B of the circular base slot 2023 on the container 2002. The third arm 2025C may be sized and shaped to cooperate with the slot member 2023C of the circular base slot 2023 on the container. The second side 2024B may include a smooth surface to cooperate and add friction to the base 2022 and the canister 2002. The circular base slot 2023 and base bumper 2024 may be different shapes and include different interlocking features, without departing from the scope of these disclosures.

In another example, as depicted in FIG. 23C, the canister 2002 and first end 2012 may include a ledge 2017 within the base 2022. The ledge 2017 may be a molded horizontal ledge feature added to a recess in the base 2022. The ledge feature 2017 may assist the user when gripping, holding, and pouring the container 2000.

In yet another example, as depicted in FIG. 23C, the canister 2002 may include the first end 2012 may include a base grip 2019 that extends along a portion of the first end 2012 and the base 2022. The base grip 2019 may help the user grip and pour the canister 2002. The base grip 2019 may be a rubber bumper that includes grip details along a portion of the base 2022 for the user when tightening and loosening the cap 2008.

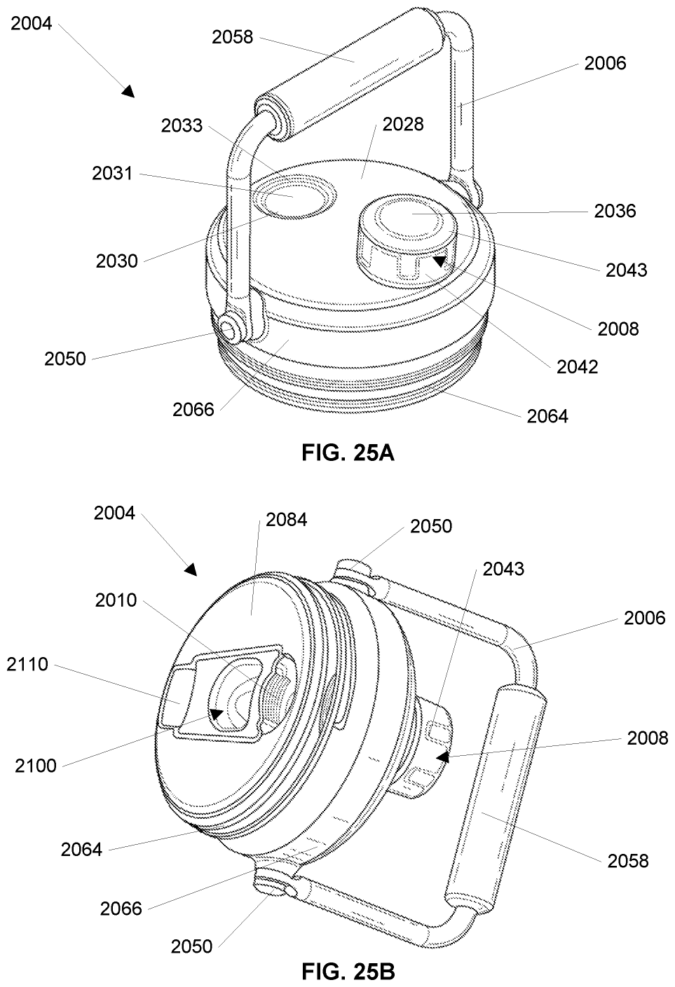

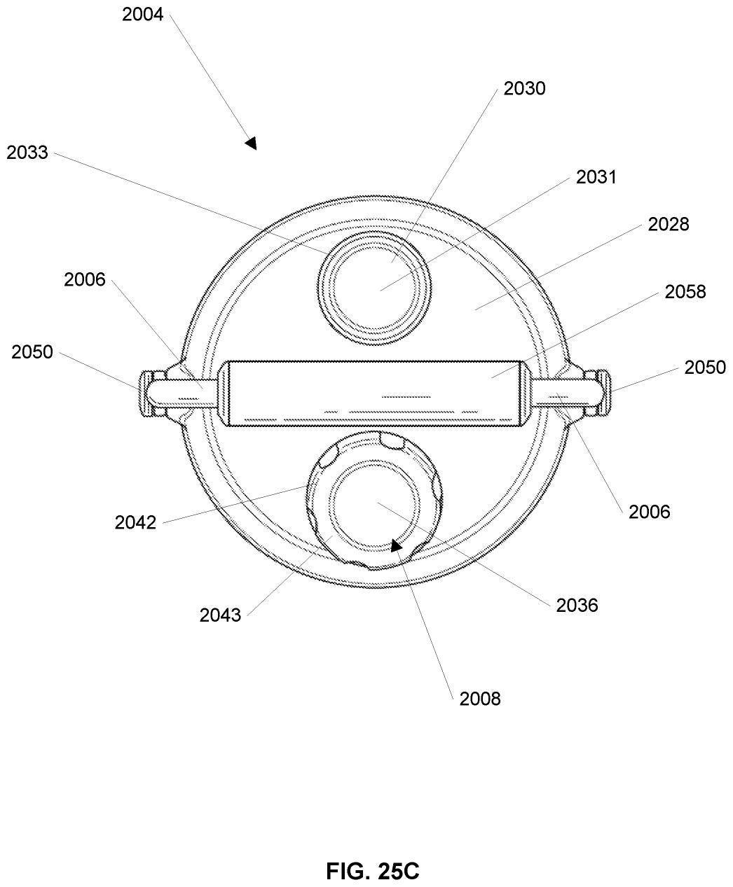

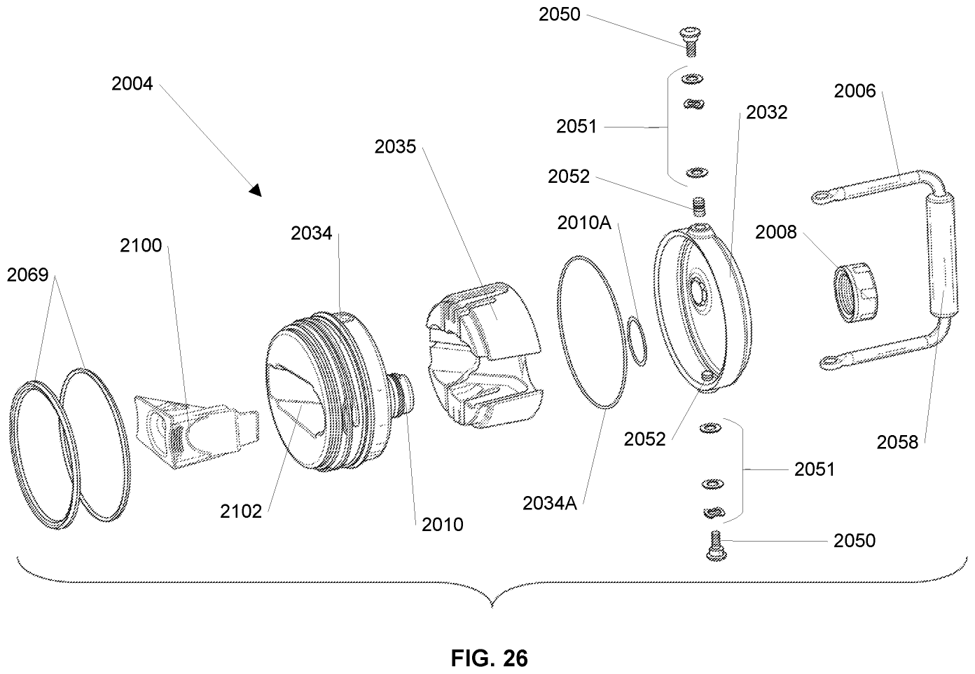

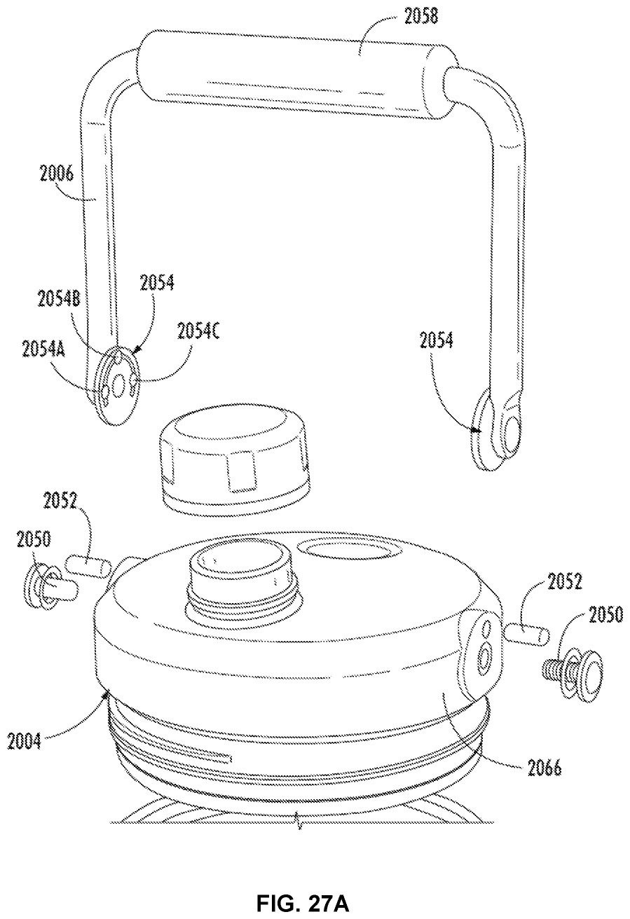

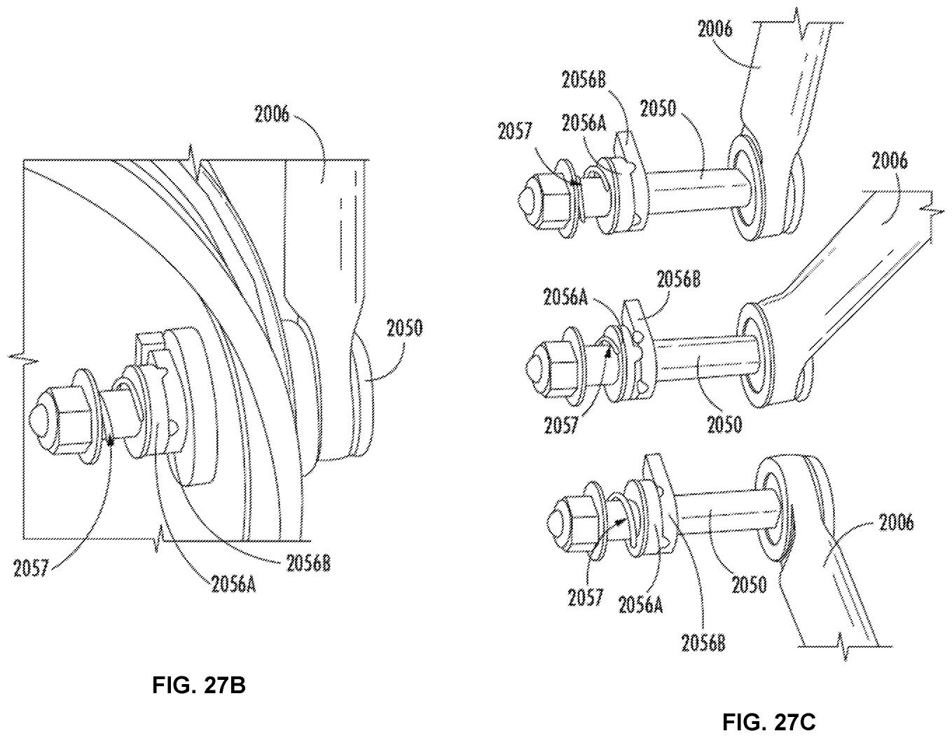

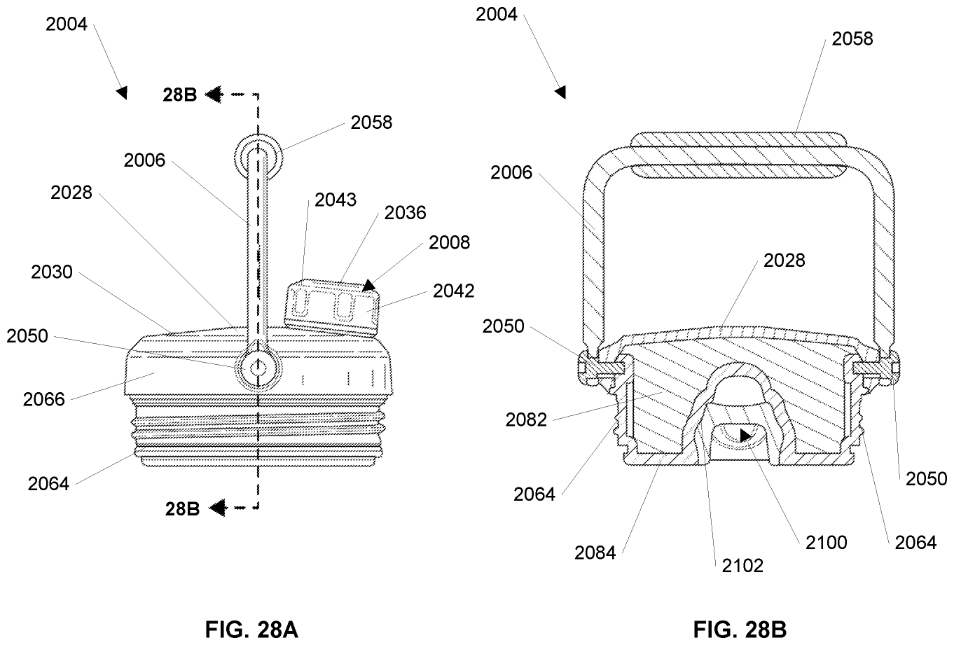

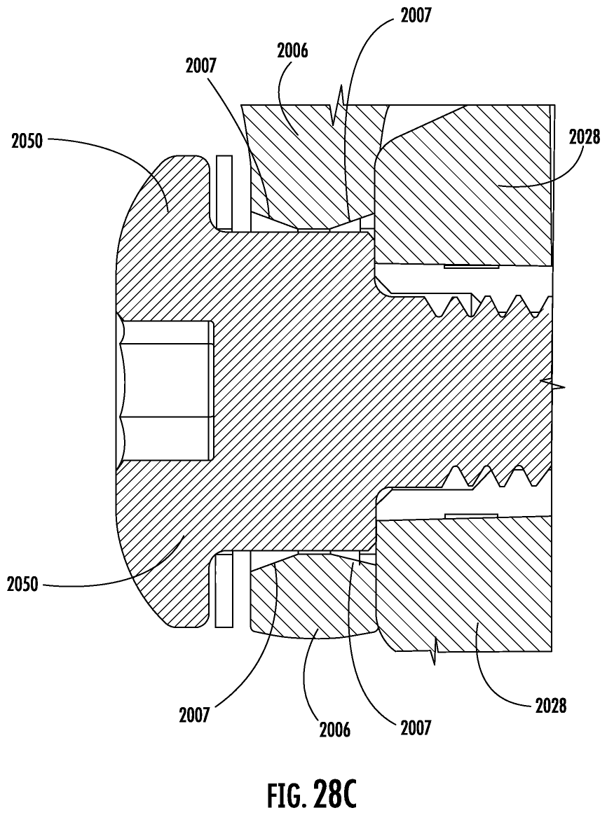

FIGS. 25A-28C depict various views and various portions of the lid assembly 2004. FIGS. 25A and 25B depict perspective views of the lid assembly 2004. FIG. 25C depicts a top view of the lid assembly 2004. FIG. 26 depicts an exploded component view of the lid assembly 2004. FIG. 27A depicts an exploded component view of an indexing handle assembly. FIGS. 27B and 27C depict various views of another indexing handle assembly. FIG. 28A depicts a side view of the lid assembly 2004. FIG. 28B depicts a cross-section view of the lid assembly 2004 along 28B-28B from FIG. 28A. FIG. 28C depicts a cross-section view of a portion of the lid assembly 2004 from FIG. 2B.

FIG. 26 illustrates an exploded component view of the lid assembly 2004. As depicted in FIG. 26, the lid assembly 2004 may include: a lid bottom 2034 and a lid top 2032 with a foam insulation layer 2035 fit between the lid bottom 2034 and the lid top 2032. The lid bottom 2034 may include a vent core body 2100 that fits within in a vent core cavity 2120 of the lid bottom 2034 as will be described and detailed more below. The lid bottom 2034 may also include the spout 2010. The lid bottom 2034 may include one or more gaskets 2069 to be located between the lid assembly 2004 and the lid bottom 2034 and the container 2002. One or more lid induction coils 2034A may be located between the lid bottom 2034 and the lid top 2032. One or more spout induction coils 2010A may be located between the lid bottom 2034, the spout 2010 and the lid top 2032. The lid top 2032 may include a top surface 2028 and a cap 2008 to cover the spout 2010. The carry handle structure 2006 may be attached to opposite sides of the lid top 2032 using a fastener 2050, one or more washers/coils springs 2051, and a threaded insert and/or a spring-ball plunger 2052. The carry handle structure 2006 may also include a grip structure 2058.

In one implementation, the lid assembly 2004 may be configured with a circular domed (convex) top surface 2028. In one implementation, the cap 2008, when removed from the spout 2010, may be positioned within a dimple 2030, otherwise referred to as a recess structure 2030 (depicted in the views of container 2000 of FIGS. 16A and 17 and lid assembly 2004 of 25A and 25C). In one implementation, when positioned within the dimple 2030, the cap 2008 may be angled away from the spout 2010, as schematically depicted in FIGS. 25A and 25C.

Additionally, the cap 2008 may be removed from the spout 2010 and positioned within the dimple 2030. In various examples, the spout 2010 extends from the substantially convex geometry of the circular domed top surface 2028. Advantageously, and in various examples, the relative positioning of the spout 2010 and the cap 2008 may allow for improved separation, such that the cap 2008 is not contacted when a user is drinking from/pouring from the spout 2010.

In one implementation, the circular domed top surface 2028 may have a radius of curvature equal to approximately 13.5 inches (342 mm). However, in other implementations, any radius of curvature may be utilized to form the convex geometry of the circular domed top surface 2028, without departing from the scope of these disclosures. Additionally or alternatively, the circular domed top surface 2028 may comprise multiple radii of curvature, without departing from the scope of this disclosure.

In another implementation, the lid assembly 2004 may be configured with other top surface geometries than that circular domed top surface 2028 depicted in FIGS. 25A and 25C. For example, the lid assembly 2004 may have a substantially planar, or a substantially concave top surface, among others (not pictured).

In one implementation, the dimple 2030 may have a substantially circular geometry. In particular, the dimple 2030 may have a concave geometry. Accordingly, a concave geometry of dimple 2030 may be embodied with any radius of curvature, without departing from the scope of these disclosures. In another example, the dimple 2030 may have a flat bottom (i.e. substantially planar) surface 2031 connected to the circular domed top surface 2028 by a sidewall 2033. In one example, the sidewall 2033 may be straight, chamfered, or filleted. As such, in one implementation, the dimple 2030 may have an inner diameter, an outer diameter, and a depth. For that implementation of dimple 2030 having a straight sidewall 2033 between the bottom surface 2031 and surface 2028, the inner diameter may be approximately equal to the outer diameter.

In one specific example, the inner diameter may measure approximately 25.5 mm, and the outer diameter may measure approximately 29.4 mm. In another example, the inner diameter may measure up to approximately 28 mm, and the outer diameter may measure up to approximately 30 mm. In other examples, the inner diameter and the outer diameter may be embodied with any dimensions, without departing from the scope of these disclosures. In one implementation, the depth of the dimple 2030 may range from 1 mm or less to 5 mm or more. However, the depth may be embodied with any value, without departing from the scope of this disclosure. Further, the sidewall 2033, if chamfered, may be angled at any angular value between the bottom surface 2031 and the surface 2028. Similarly, the sidewall 2033, if filleted, may have any radius of curvature between the bottom surface 2031 and the surface 2028.

In one implementation, the bottom surface 2031 may be a magnetic surface 2031 and may comprise a polymer outer layer over a ferromagnetic structure (i.e. a metal plate may be positioned below magnetic surface 2031 in order for the magnetic surface 2031 to attract a magnet embedded within a magnetic top surface 2036 of the cap 2008. In another implementation, the magnetic surface 2031 may comprise a polymer overmolded over a magnet structure (i.e. a magnet may be positioned within the lid assembly 2004 as it is being molded.

The term “magnetic,” as utilized herein, may refer to a material (e.g. a ferromagnetic material) that may be magnetized. As such, the term “magnetic” may imply that a material (i.e. a surface, or object, and the like) may be magnetically attracted to a magnet (i.e. a temporary or permanent magnet) that has an associated magnetic field. In one example, a magnetic material may be magnetized (i.e. may form a permanent magnet). Additionally, various examples of magnetic materials may be utilized with the disclosures described herein, including nickel, iron, and cobalt, and alloys thereof, among others.

In one implementation, the lid assembly 2004 may be constructed from a polymeric material. In one example, the lid assembly 2004 may be injection molded. In one implementation, dimple 2030 may comprise a ferromagnetic structure, or plate, that is overmolded to form the lid assembly 2004. In this way, upon manual removal of the cap 2008 from the spout 2010, the magnetic top surface 2036 of the cap 2008 may be magnetically attracted to the dimple structure 2030 when positioned within a given proximity of the dimple structure 2030. In another example, dimple 2030 may comprise a ferromagnetic structure, or plate, that is positioned behind the bottom surface 2031 (e.g. glued, or ultra-sonically welded or otherwise attached to an interior side of the lid assembly 2004 within the cavity 2082).

In one example a force needed to remove the cap 2008 from the dimple structure 2030 (i.e. a force to overcome a magnetic attraction between the cap 2008 and the dimple structure 2030) may measure approximately 10 N. In another example, the force to remove cap 2008 from the dimple structure 2030 may range between approximately 7 and 15 N. In another implementation, magnetic top surface 2036 may be magnetically coupled to the curved sidewall 2018 of the canister 2002. Accordingly, in one example, a force needed to overcome a magnetic attraction between the cap 2008 and the curved sidewall 2018 may measure approximately 3 N. In another example, the force to remove the cap 2008 from the curved sidewall 2018 may range between approximately 1 and 10 N.

In another implementation, there may be a specific distance/proximity within which magnetic attraction is exerted between the magnetic top surface 2036 of the cap 2008, and the ferromagnetic structure of the dimple 2030. This proximity may be dependent upon a strength (magnetic field strength, and the like) of the magnet contained within the magnetic top surface 2036, among other factors. As such, there may exist a proximity within which the magnetic top surface 2036 of the cap 2008 may be positioned relative to the dimple structure 2030 in order to magnetically couple the two structures may be embodied with any distance value. This proximity may be embodied with any value, without departing from the scope of the disclosures described herein. Accordingly, any strength of magnet may be utilized with the disclosures described herein. Additionally, various ferromagnetic materials may be utilized within the dimple structure 2030, without departing from the disclosures described herein.

In another example, a ferromagnetic material may be positioned within the dimple structure 2030, and such that an overmolding process is not utilized to cover the ferromagnetic material. Similarly, a magnet may be positioned on the magnetic top surface 2036 of the cap 2008, and such that the magnet is exposed, rather than being overmolded or covered.

In various examples, the container 2000 may be configured such that the magnetic top surface 2036 of the cap 2008 is configured to magnetically couple only within the recess 2030. As such, the remainder of container 2000 may be constructed using one or more non-magnetic materials. In another example, a magnetic top surface 2036 of the cap 2008 may be configured to magnetically couple to one of a plurality of locations on the lid assembly 2004. In particular, in one example, the circular domed top surface 2028 of the lid assembly 2004 may comprise a plurality of overmolded ferromagnetic pieces configured to magnetically couple to the magnetic top surface 2036 of the cap 2008. In another example, the lid assembly 2004 may be constructed using, or coated with, a metallic material that may be attracted to a magnetic field.

In various examples, container 2000 may be configured such that the magnetic top surface 2036 of the cap 2008 may be configured to magnetically couple to the spout 2010 (i.e. spout 2010 may be embodied with one or more ferromagnetic materials). Accordingly, the opening into the canister 2002 through the spout 2010 may be sealed by magnetic attraction of the cap 2008 to the spout 2010.

In various examples, cap 2008 may be attached within dimple 2030 using another coupling mechanism in addition to, or as an alternative to, the magnetic metric coupling between the magnetic top surface 2036 and bottom surface 2031. For example, the top surface 2036 and bottom surface 2031 may be embodied with complementary threaded coupling elements, interference fit coupling elements (i.e. snap coupling), or hook and loop coupling elements, among others.

Additionally or alternatively, the canister 2002 may comprise a magnetic material, such that the magnetic top surface 2036 may be magnetically coupled to a surface (e.g. the curved sidewall 2018) of the canister 2002. In one particular example, the canister 2002 may comprise a stainless steel material (e.g. 304 stainless steel), and may be magnetized by a one or more cold working processes used to form the various geometries of the canister 2002. However, the canister 2002, and indeed any of the structures of container 2000 described herein, may be constructed using one or more of a metal, an alloy, a polymer, a ceramic, a wood material, or combinations thereof.

In various examples, the recess or dimple 2030 may comprise an overmolded, or otherwise covered, permanent magnet, and the magnetic top surface 2036 of the cap 2008 may comprise an overmolded ferromagnetic material (e.g. iron). In yet another example, both of the magnetic top surface 2036 and the recess structure 2030 may comprise overmolded, or otherwise covered, permanent magnets configured to attract one another, and the like.

In one example, the cap 2008 may comprise a substantially planar magnetic top surface 2036. In this way, the substantially planar magnetic top surface 2036 may be configured to interface with a substantially planar surface of the recess 2030. In another example, a cap 2008 may be configured with different geometries. For example, the cap 2008 may comprise a curved top surface 2036. In another example, the cap 2008 may have a magnetic channel structure configured to allow the cap 2008 to be magnetically coupled to a curved surface. In one implementation, the magnetic channel structure may be configured to magnetically couple to one or more curved surfaces of the carry handle structure 2006. In this way, the carry handle structure 2006 may be configured with one or more magnetic materials (overmolded, covered, or exposed magnetic materials). In one implementation, one or more portions of the carry handle structure 2006 may comprise a magnet and such that one or more portions of the carry handle structure 2006 may be magnetically attracted to, and held in position when brought into contact with, sidewall 2018. In yet another example, the magnetic channel structure may have a concave geometry configured to conform to a curved surface geometry of a curved sidewall 2018 of the canister 2002. As such, the magnetic channel structure may comprise one or more overmolded, or otherwise covered, permanent magnet structures, similar to the magnetic top surface 2036 of cap 2008.

In one implementation, the cap 2008 may be embodied with additional or alternative features. For example, the cap 2008 may be embodied with a tether connected between a first anchor point on the cap 2008 and a second anchor point on the lid assembly 2004. The first anchor point and the second anchor point can be in the form of U-shaped connectors that are either separately fastened or integrally molded. Advantageously, the tether may be utilized to prevent separation of the cap 2008 and the lid assembly 2004, and may be utilized in combination with a magnetic coupling between a magnetic top surface 2036 and a recess 2030, such that the magnetic coupling prevents the cap 2008 from falling into a stream of liquid being poured from the spout 2010, among others. As such, the tether may comprise any flexible material, such as a polymer, a metal, or an alloy, among others, and may be embodied with any length. Similarly, the first anchor point and the second anchor point may be positioned at different locations on the cap 2008 and the lid assembly 2004, respectively, without departing from the scope of the disclosures described herein.

The cap 2008 may be configured with a substantially cylindrical geometry. In one implementation, the cap 2008 may comprise a magnetic top surface 2036. As such, the cap 2008 may be configured to removably couple to, and seal, the spout 2010. Further, upon manual removal of the cap 2008 from the spout 2010, the magnetic top surface 2036 may be configured to magnetically couple to a magnetic surface 2031 of the dimple 2030. As such, the dimple 2030 may comprise a magnetic material to which the magnetic top surface 2036 may be magnetically attracted.

In one example, the cap 2008 may be constructed from a polymer material, and formed using one or more injection molding processes. As such, the magnetic top surface 2036 may comprise an overmolded permanent magnet. Various permanent magnet materials may be utilized with the magnetic top surface 2036 of cap 2008, without departing from the scope of the disclosures described herein. In one particular example, the magnetic top surface 2036 may comprise a neodymium magnet of grade N30, among others. Furthermore, various overmolding methodologies may be utilized to encapsulate a magnet within the cap 2008, without departing from the scope of the disclosures described herein. In another example, the cap 2008 may comprise a permanent magnet coupled below the polymeric magnetic top surface 2036 such that the permanent magnet may be ultra-sonically welded, or glued onto a surface within the cap 2008 (e.g. magnet may be retained within the cap 2008, which may comprise a polymer plate that is ultra-sonically welded, glued, or otherwise coupled to the cap 2008).

Advantageously, a magnetic coupling between the magnetic top surface 2036 of cap 2008, and the magnetic surface 2031 of dimple 2030 may provide for fast, temporary storage of cap 2008 while a liquid is being poured from container 2000. In this way, a user may quickly affix cap 2008 into dimple 2030 such that cap 2008 may not be set aside on an external surface where it may be misplaced or contaminated. Further advantageously, a magnetic coupling between the magnetic top surface 2036 of the cap 2008 and a magnetic surface 2031 of the dimple 2030 may encourage surfaces 2036 and 2031 to contact one another such that a bottom surface of cap 2008 does not contact the magnetic surface 2031 of the dimple 2030. In this way one or more surfaces, including the bottom surface of cap 2008 may be exposed to fewer contaminants, and thereby reduce transmission of fewer contaminants to spout 2010 upon re-coupling of the cap 2008 with the spout 2010. It is noted that the previously described advantages with regard to magnetically coupling the cap 2008 into the dimple 2030 may, additionally or alternatively, be realized with cap 2008 from container 2000.

In one example, cap 2008 may comprise one or more polymer materials. However, cap 2008 may comprise one or more of a metal, an alloy, a ceramic, or a wood material or combinations thereof, without departing from the scope of the disclosure described herein.

In one example, cap 2008 may have a substantially cylindrical shape with a cylindrical outer wall. As such, cap 2008 may be embodied with any outer diameter for the outer wall, without departing from the scope of this disclosure. In one example, cap 2008 may have a surface 2043 extending between the magnetic top surface 2036 and a side surface 2042. In one implementation, the surface 2043 may form a chamfer between the top surface 2036 and the side surface 2042. As such, surface 2043 may be embodied with any chamfer angle between the top surface 2036 and the side surface 2042. In another implementation, surface 2043 may form a fillet between the top surface 2036 on the side surface 2042. As such, an example filleted surface 2043 may be embodied with any desired fillet angle or radius. In one implementation, surface 2043 may be utilized to center the cap 2008 within the dimple 2030. In one implementation, a fillet radius of surface 2043 may be approximately equal to a fillet radius of surface (sidewall) 2033 of the dimple 2030. Similarly, and in another implementation, a chamfer angle of surface 2043 may be approximately equal to a chamfer angle of surface (sidewall) 2033 of dimple 2030. In one example, the cap 2008 may have lip structures to facilitate manual gripping of the cap 2008 to remove upon removal of the cap 2008 from the spout 2010 or the dimple 2030, among others. In another implementation, the cap 2008 may be implemented such that outer wall has an outer diameter equal to the outer diameter of surface 2042, and such that the cap 2008 is not embodied with lip structures.

In one example, the spout 2010 may be off-center on the circular domed top surface 2028. In particular, the spout 2010 may be positioned substantially at a perimeter of the circular domed top surface 2028. Further, in one implementation, the recess 2030 may be diametrically opposed to the spout 2010. However, the spout 2010 may be positioned in other locations on the lid 2004, without departing from the scope of the disclosure described herein. For example, the spout 2010 may be positioned substantially at a center of the circular domed top surface 2028. In another example, the spout 2010 may be positioned on a curved sidewall of the lid assembly 2004, such as the curved sidewall 2040. In another example, the recess 2030 may not be diametrically opposed to the spout 2010. As such, in one example, the recess 2030 may be positioned substantially at a center of the domed top surface 2028, while the spout 2010 may be positioned substantially at the perimeter of the circular domed top surface 2028.

In one implementation, as depicted in FIG. 27A, the carry handle 2006 may be rotatably coupled to the lid assembly 2004 with a spring-ball plunger 2052 and detents for handle indexing. For example, the carry handle structure 2006 may be rotatable about an axis through a fastener 2050 that couples the carry handle structure 2006 to the lid assembly 2004. The handle indexing may be defined by, for example, the carry handle 2006 locking at the zero degrees (horizontal-right) position, ninety degrees (vertical) position, or the 180 degrees (horizontal-left) position. Between each of these positions, the carry handle 2006 may be free floating. The spring-ball plunger 2052 may be a spring plunger with a ball head. The spring-ball plunger 2052 may be located within the lid assembly 2004, and specifically located in the outer wall 2066 of the lid assembly 2004. The spring-ball plunger 2052 may cooperate and fit within one or more detents on a handle detent plate 2054 located on the carry handle 2006. The handle detent plate 2054 may include the one or more handle detents. The spring-ball plunger 2052 may fit within the one or more detents within the lid assembly 2004 with the fastener 2050 attached to each side of the carry handle 2006. As depicted in FIG. 27A, the handle detent plate 2054 may include three handle detents: a first handle detent 2054A for locking the carry handle 2006 at the zero degrees (horizontal-right) position, a second handle detent 2054B for locking the carry handle 2006 at the ninety degrees (vertical) position, and a third handle detent 2054C for locking the carry handle 2006 at the 180 degrees (horizontal-left) position. The handle detent plate 2054 may have other numbers of handle detents without departing from the scope of these disclosures, thereby providing different index locking positions for the carry handle 2006.

In another implementation, as depicted in FIGS. 27B and 27C, the carry handle structure 2006 may be rotatably coupled to the lid assembly 2004 with handle indexing that includes indexing washers 2056A, 2056B on a fastener 2050 on each side of the carry handle 2006. For example, the carry handle structure 2006 may be rotatable about an axis through the fastener 2050 that couples the carry handle structure 2006 to the lid assembly 2004. Similar to the implementation depicted and described with FIG. 27A, the handle indexing may be defined by, for example, the carry handle 2006 locking at the zero degrees (horizontal-right) position, ninety degrees (vertical) position, or the 180 degrees (horizontal-left) position. Between each of these positions, the carry handle 2006 may be free floating. For the implementation depicted in FIGS. 27B and 27C, the indexing washers 2056A, 2056B may cooperate and engage with each other to lock and hold the carry handle 2006 in each of the three different positions. Each of the fasteners 2050 may also include a spring 2057, such as a coil spring to provide pressure when locking and unlocking the indexing washers 2056A, 2056B along the carry handle 2006. The indexing washers 2056A, 2056B may include grooves and projections to facilitate the locking and unlocking. The indexing washers 2056A, 2056B may provide other different index locking positions without departing from the scope of these disclosures, thereby providing different index locking positions for the carry handle 2006.

In another implementation, the carry handle structure 2006 may be rotatably coupled to the lid assembly 2004, such that the carry handle structure 2006 may be rotated from various positions without handle indexing. For example, the carry handle structure 2006 may be rotatable about an axis through a fastener 2050 that couples the carry handle structure 2006 to the lid assembly 2004 without locking and unlocking of the handle assembly in any positions.

In one implementation, the carry handle structure 2006 may be rotatable about axis 103 through an angle of greater than 320°. In another example, the carry handle structure 2006 may be rotatable about axis 103 through an angle of greater than 300°, greater than 280°, greater than 260°, greater than 240°, or greater than 220°, among others. The carry handle 2006 may comprise a grip structure 2058. The grip structure 2058 may be in the form of a sleeve. The grip structure 2058 may have a larger diameter than the carry handle 2006. The carry handle 2006 may include a polymeric grip and/or the grip structure 2058 may be formed from a polymeric material.

In another implementation, the carry handle structure 2006 may be rotatably coupled to the lid assembly 2004, such that the carry handle structure 2006 may be rotated from various positions, similar to any of the carry handle structures 2006 depicted in FIGS. 25A-27C. The carry handle structure 2006, as depicted in FIG. 28C, may include chamfered handle hole openings or chamfered edges 2007 located around the hole for the fastener 2050. The chamfered edges 2007 may be on the internal side of the hole for the fastener 2050 and/or the external side of the hole for the fastener 2050. The chamfered edges 2007 located on the carry handle structure 2006 may reduce stress on the plastic part when the handle bends.

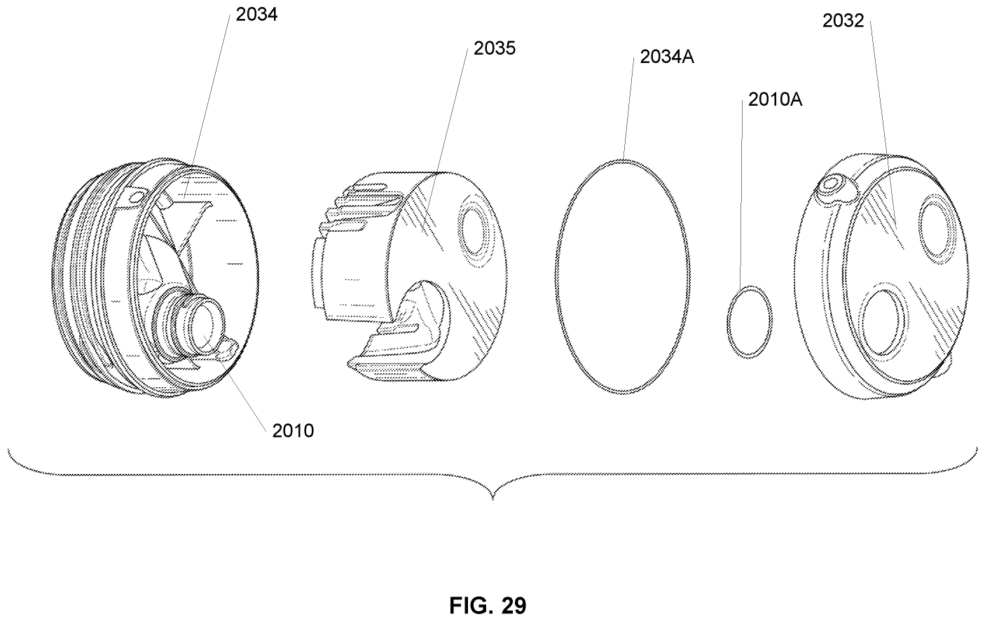

FIGS. 29-38C depict various views and various portions of the lid bottom 2034 and the lid assembly 2004. FIGS. 29-34B depict various views of the lid assembly 2004 and an integrated anti-glug venting feature 2100 within the removable lid 2004. The integrated anti-glug venting feature 2100 may include a vent formed by a triangular wedge that is pressed into the underside of the lid bottom 2034 and the lid 2004. The vent may be removable, as described, but the vent may also be permanently attached during assembly. The vent may also be totally integrated into the lid 2004 as part of the materials.

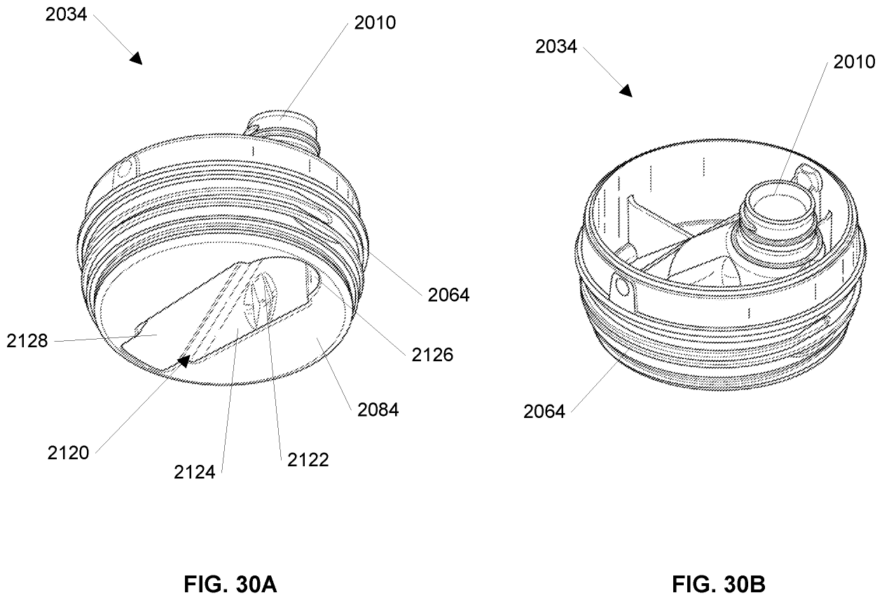

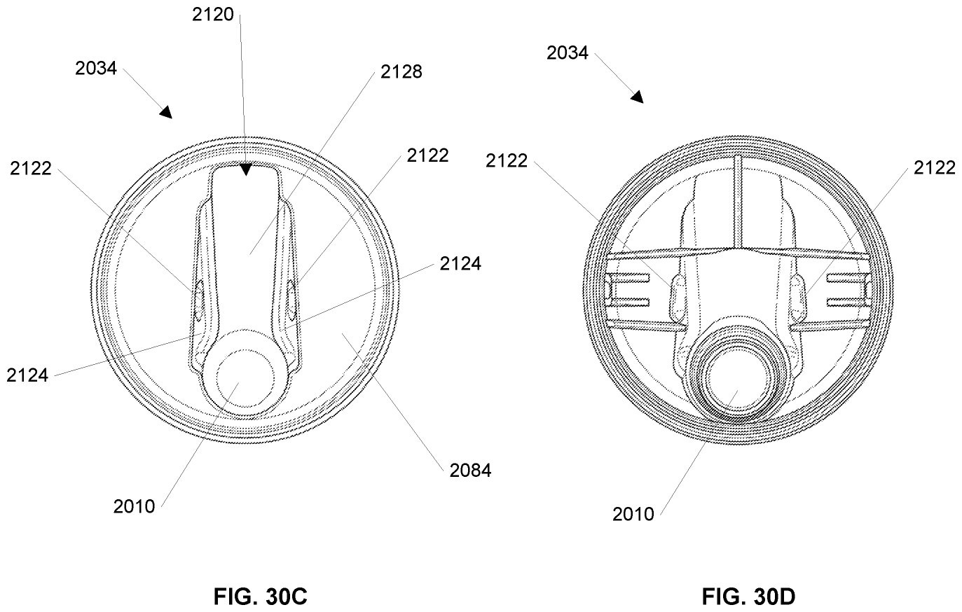

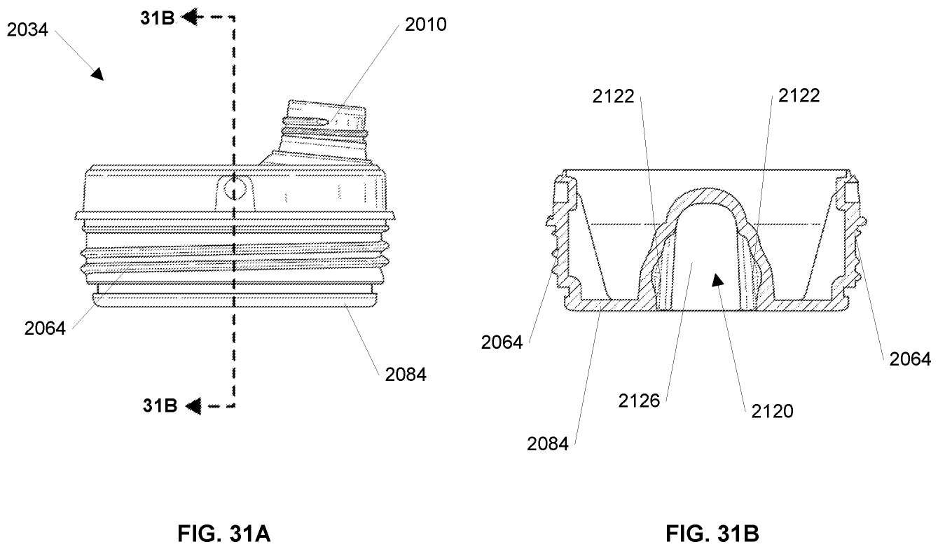

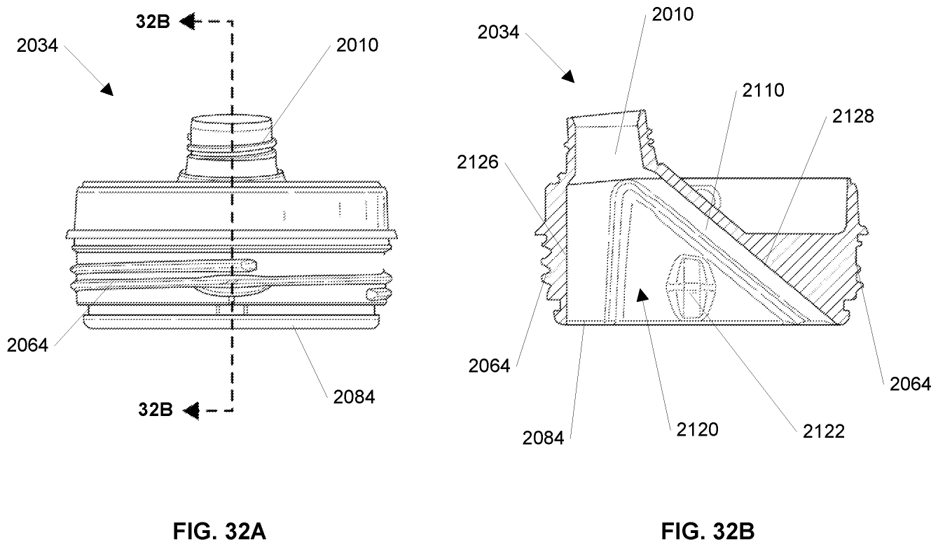

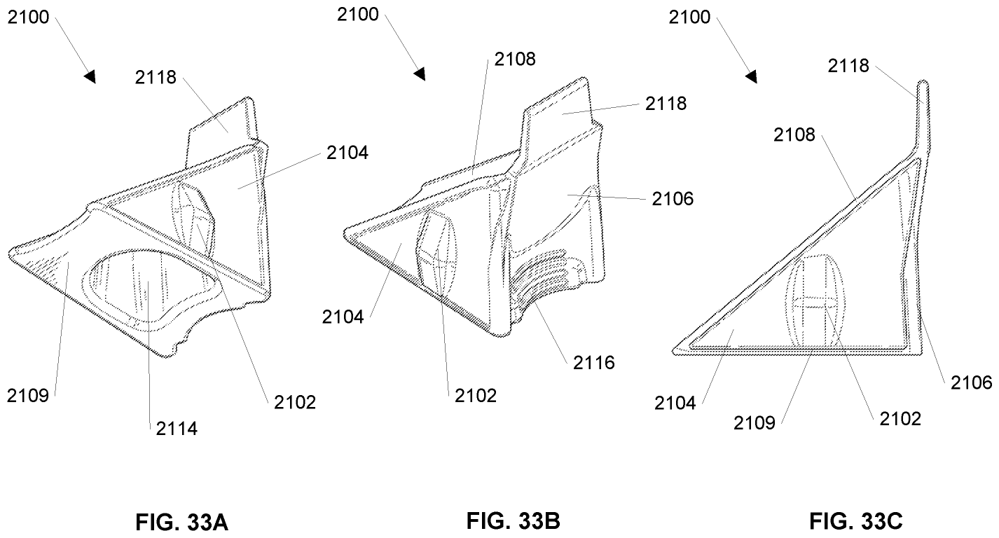

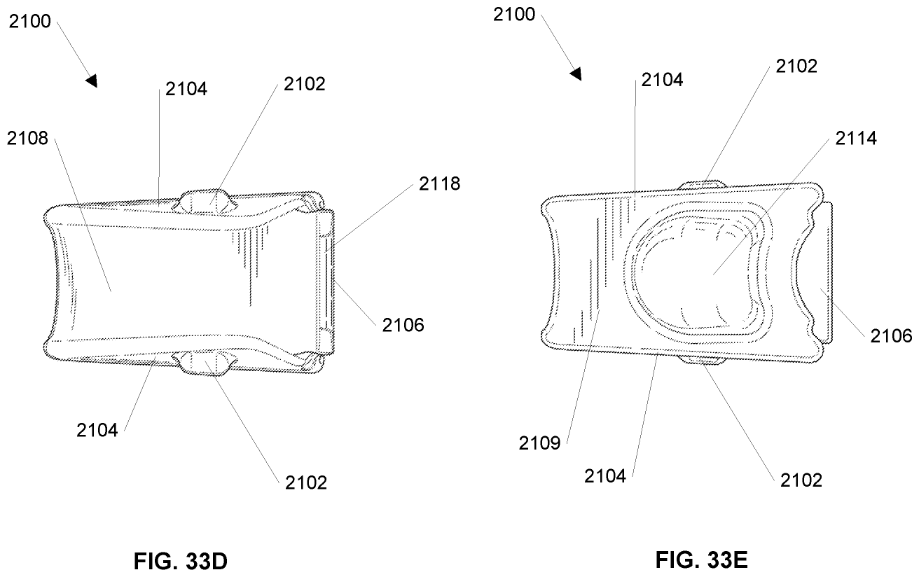

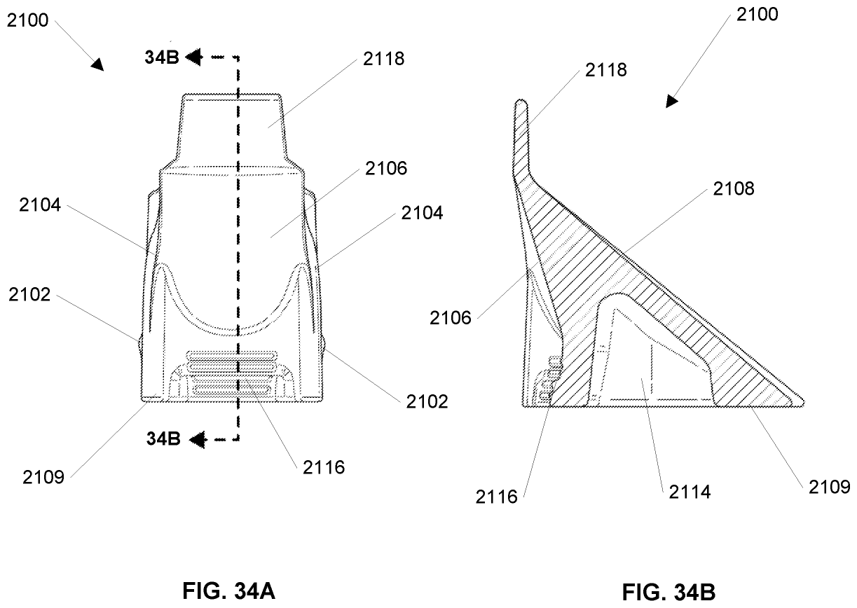

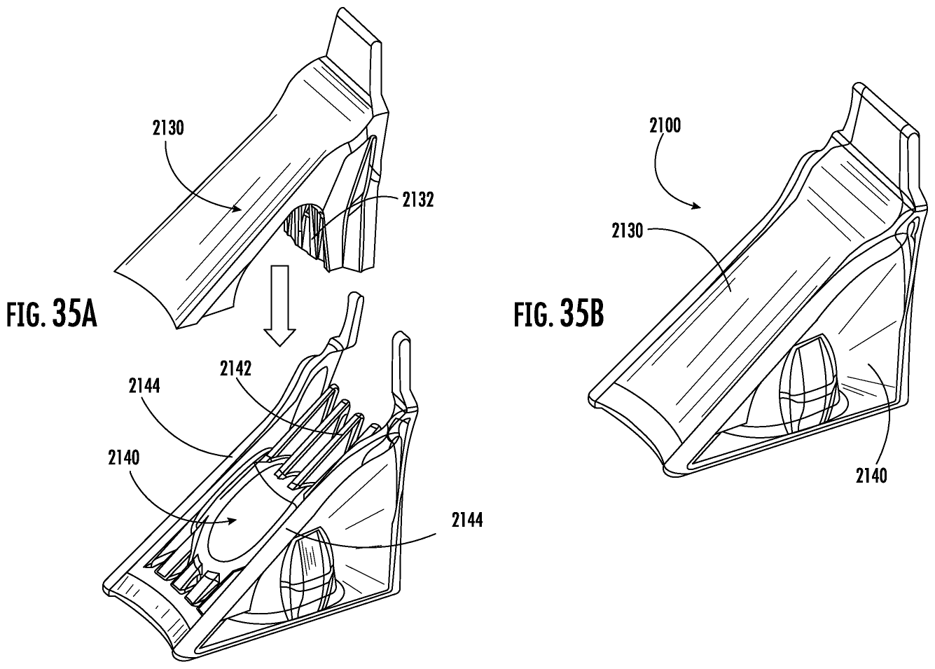

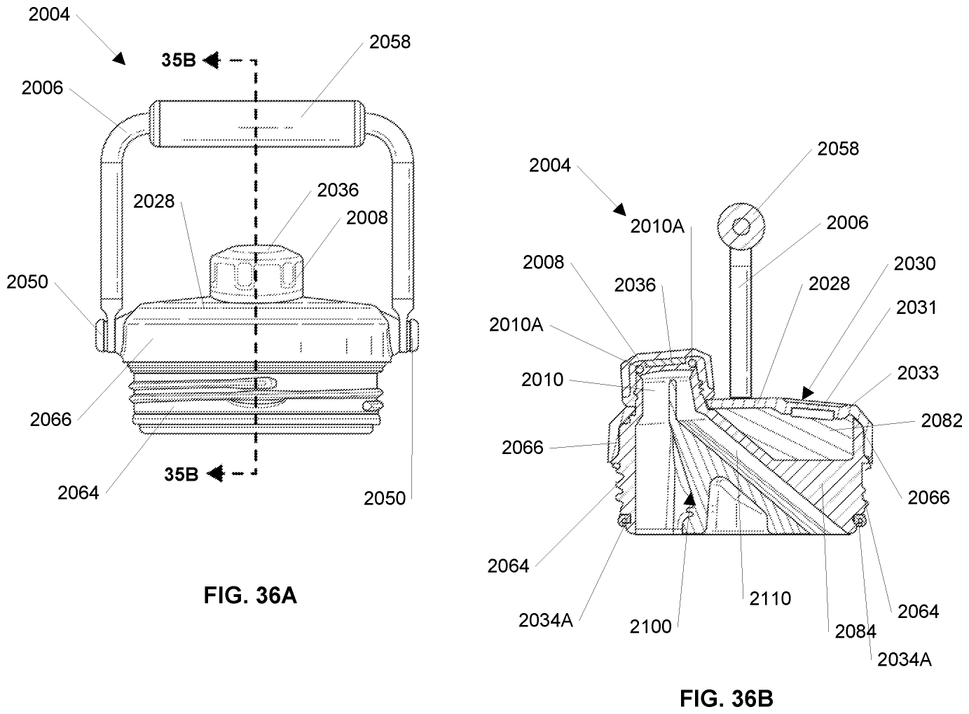

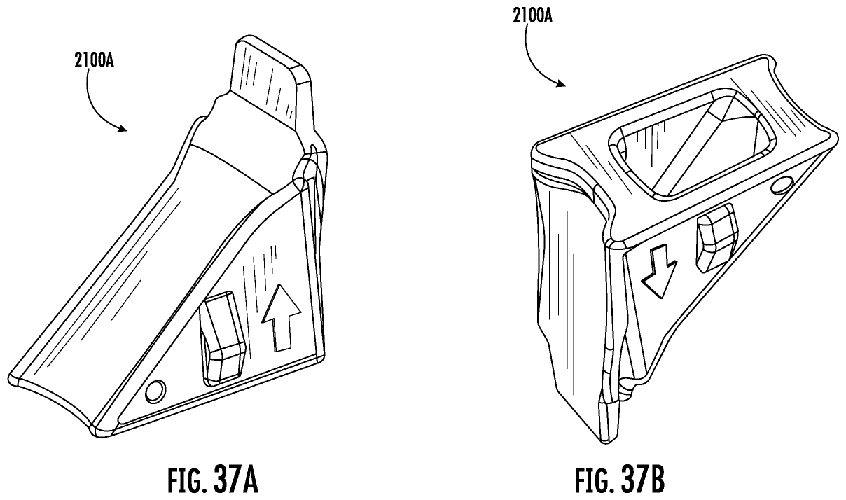

FIG. 29 depicts an exploded component view of portions of the lid 2004. FIGS. 30A and 30B depict perspective views of the lid bottom 2034. FIG. 30C depicts a top view of the lid bottom 2034 and FIG. 30D depicts a bottom view of the lid bottom 2034. FIGS. 31A and 32A depict side views of the lid bottom 2034. FIG. 31B depicts a cross-section view of the lid bottom 2034 along 31B-31B from FIG. 31A. FIG. 32B depicts a cross-section view of the lid bottom 2034 along 32B-32B from FIG. 32A. FIGS. 33A-33E depict various views of the vent portion 2100 that fits into the lid bottom 2034 from the lid 2004. FIG. 34A depicts a side view of the vent portion 2100. FIG. 34B depicts a cross-section view of the vent portion 2100 along 34B-34B from FIG. 34A. FIGS. 35A and 35B depict views of the substrate 2130 and overmold 2140 that form the vent portion 2100. FIG. 36A depicts a side view of the lid assembly 2004 with the vent portion 2100 fit inside the lid bottom 2034. FIG. 36B depicts a cross-section view of the lid assembly 2004 along 36B-36B from FIG. 36A. FIG. 37A depicts a top perspective view of another vent portion 2100A and FIG. 37B depicts a bottom perspective view of the vent portion 2100A.

FIG. 29 depicts an exploded component view of the lid 2004. As depicted in FIG. 29, the lid 2004 may include various components, such as: a lid bottom 2034 and a lid top 2032 with a foam insulation layer 2035 fit between the lid bottom 2034 and the lid top 2032. The lid bottom 2034 may include a vent core body 2100 that fits within in a vent core cavity 2120 of the lid bottom 2034 as will be described and detailed more below. The lid bottom 2034 may also include the spout 2010. One or more lid induction coils 2034A may be located between the lid bottom 2034 and the lid top 2032. One or more spout induction coils 2010A may be located between the lid bottom 2034, the spout 2010 and the lid top 2032.

FIGS. 30A through 32B depict various views of the lid bottom 2034 without the anti-glug feature of the vent core body 2100. These figures depict the lid bottom 2034 that includes a vent core cavity 2120 where the vent core body 2100 may fit into. The vent core cavity 2120 may extend from the bottom surface 2084 of the lid bottom 2034 through to the spout 2010. As depicted in the figures, the vent core cavity 2120 may be triangular wedge-shaped and sized and shaped to fit the vent core body 2100. The vent core cavity 2120 may include two side walls 2124, a back wall 2126, and a sloping wall 2128 configured to fit the vent core body 2100.

The vent core cavity 2120 may include one or more locating indentations 2122 located in the side walls 2124. The locating indentations 2122 may cooperate and engage with one or more corresponding locating protrusions 2102 in the vent core body 2100. The vent core cavity 2120 and vent core body 2100 may also include other locating features other than the locating indentations 2122 and the locating protrusion 2102. As depicted in the figures, the locating indentations 2122 and the locating protrusions 2102 may be in the shape of a diamond or rectangle. The locating indentation 2122 and locating protrusions 2102 may be other shapes and sizes without departing from the scope of the present disclosure. For example, the vent core body 2100 and vent core cavity 2120 may include other locating features, such as corresponding ribs and slots, cylinders and holes, snaps, etc. Additionally, the vent core cavity 2120 may include one or more protrusions and the vent core body 2100 may include one or more indentations without departing from the scope of the present disclosure. The locating indentations 2122 and locating protrusions 2102 to hold the vent core body 2100 in place can take many forms. For example, the locating indentations 2122 and locating protrusions 2102 may be switched on the vent core body 2100 and the lid bottom 2034, i.e. the locating protrusions 2102 may protrude from the lid bottom 2034 instead of the vent core body 2100 to cooperate and engage with locating indentations 2122 on the vent core body 2100.

FIGS. 33A through 34B depict the vent portion 2100 or vent core body 2100 according to one implementation. The vent portion 2100 may include may include two side surfaces 2104, a back surface 2106, a sloping surface 2108, and a bottom surface 2109 configured to fit the vent core cavity 2120. The two side surfaces 2104 may cooperate and engage with the two side walls 2124 of the vent core cavity 2120. The back surface 2106 may cooperate and engage with the back wall 2126 of the vent core cavity 2120. The sloping surface 2108 may cooperate and engage with the sloping wall 2128 of the vent core cavity 2120. The bottom surface 2109 may lay flush with or approximately flush with the bottom surface 2084 of the lid bottom 2034. The vent portion 2100 and the bottom surface 2109 may include an opening 2114. The vent portion 2100 and the back surface 2106 may include ridges 2116. Both the opening 2114 and the ridges 2116 may be utilized to assist with removing and/or installing the vent portion 2100. The vent portion 2100 and the back surface 2106 may also include a tab 2118 that extends from the back surface 2106 and the sloping surface 2108. The tab 2118 may extend in a similar, parallel plane in the back surface 2106. When the vent portion 2100 is located within the vent core cavity 2120 and the lid 2004, the tab 2118 may separate and divide the liquid pouring from the spout 2010 and the air venting from the spout 2010.

As depicted in FIGS. 35A and 35B, the anti-glug venting feature 2100 may include a vent wedge rigid substrate 2130 and a vent wedge overmold 2140 that are fit together to create the vent portion 2100. The vent wedge rigid substrate 2130 may be a rigid substrate, such as Hytrel. The vent wedge overmold 2140 may be a rubber material, such as polyester. The vent wedge rigid substrate 2130 and the vent wedge overmold 2140 may be made of different materials without departing from the scope of these disclosures. The vent wedge rigid substrate 2130 may include portions that protrude through the vent wedge overmold 2140 to create a snap feature area that provides a strong grip within the vent wedge cavity 2120 and the lid 2004. Additionally, the vent wedge rigid substrate 2130 and the vent wedge overmold 2140 may include various internal ribs and slots 2132, 2142. The vent wedge overmold 2140 may include one or more flow channels 2144 to help eliminate air traps.

In other implementations, as illustrated in FIGS. 37A and 37B, the vent portion 2100A may be a single integral piece, such as a silicone compression molded piece and not made of a separate substrate and overmold portion. The vent portion 2100A may also be made of all rubber and fit into the lid bottom 2034 similar to a rubber stopper. For the embodiment of the vent portion 2100A in FIGS. 37A and 37B, the features are referred to using similar reference numerals under the “21xxA” series of reference numerals, rather than “21xx” as used in the embodiment of FIGS. 33A-36B. Accordingly, certain features of the vent portion 2100 that were already described above with respect to FIGS. 33A-36B may be described in lesser detail, or may not be described at all for the vent portion 2100A of FIGS. 37A and 37B. Additionally, any features described above with respect to the vent portion 2100 of FIGS. 33A-36B may be utilized with the vent portion 2100A.

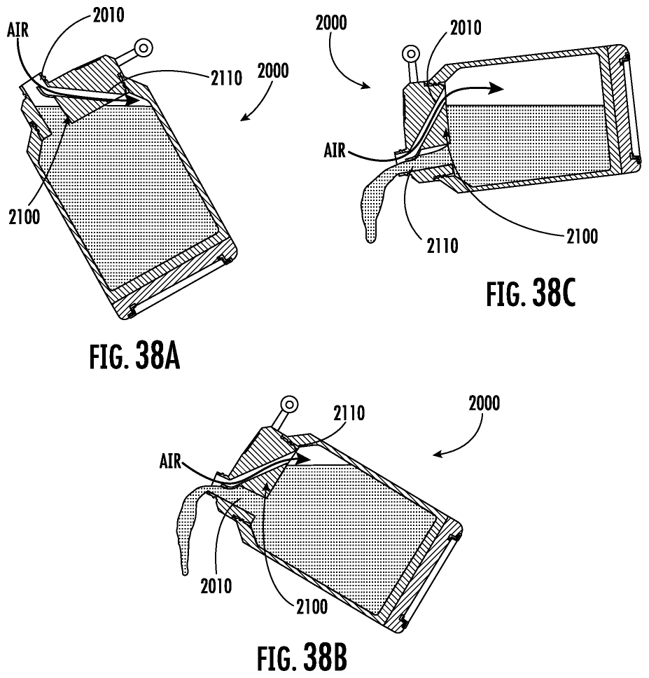

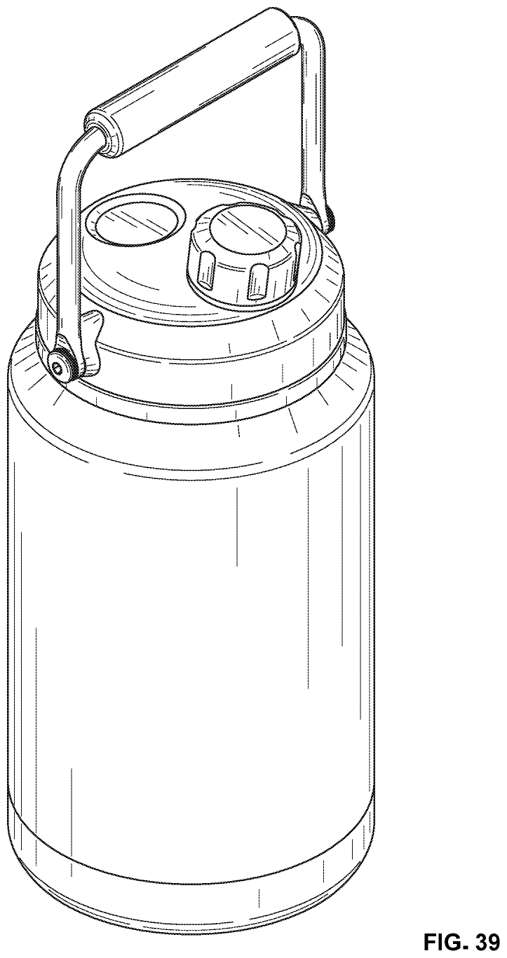

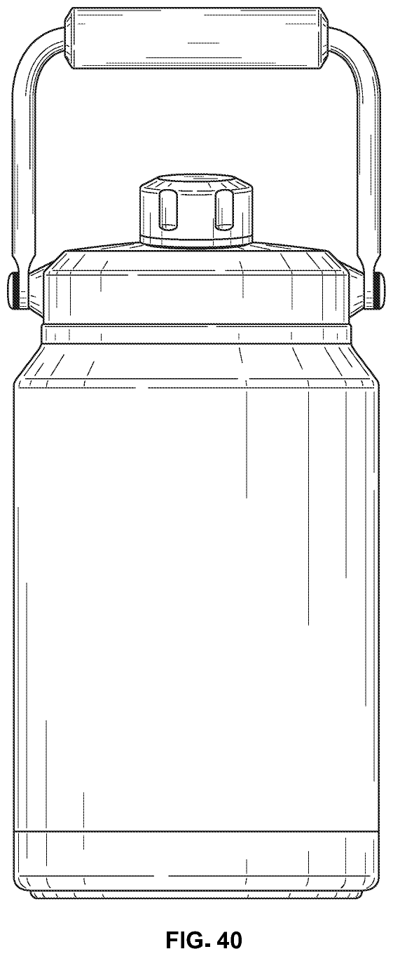

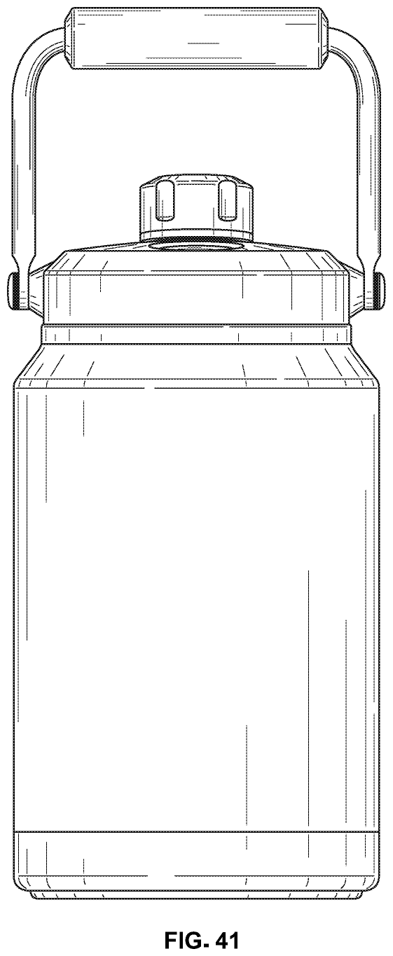

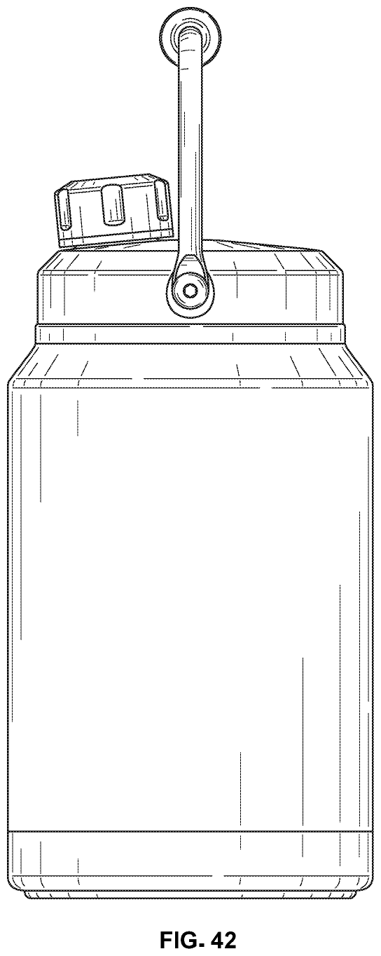

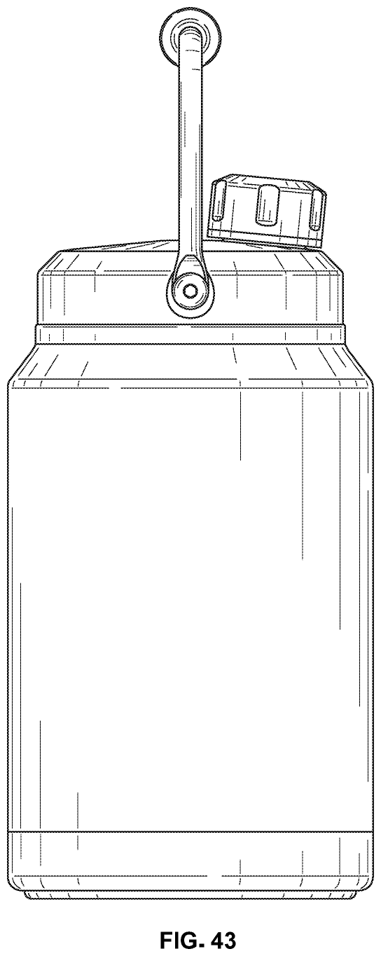

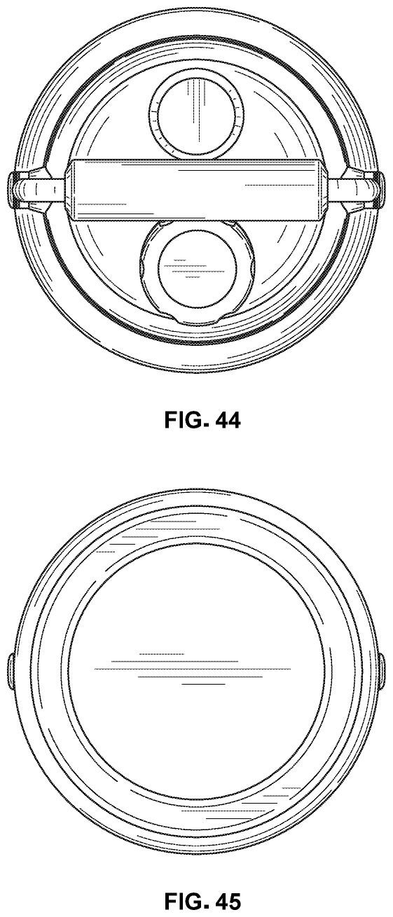

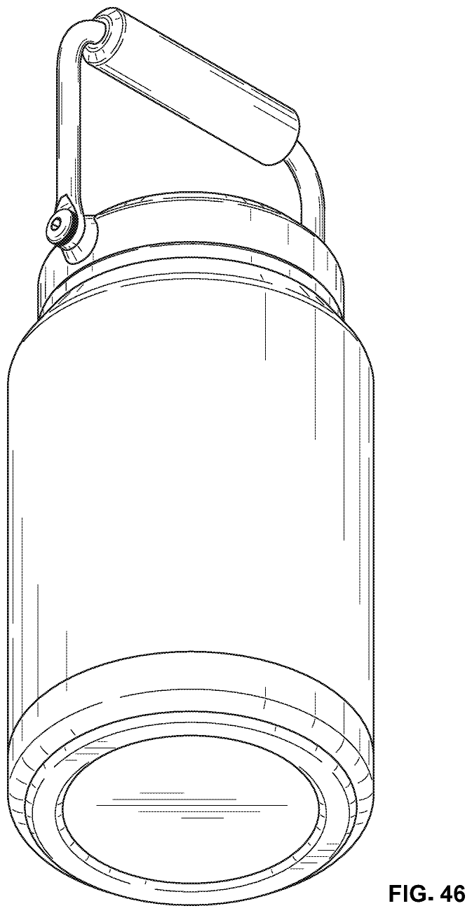

The vent portion 2100, 2100A may be pressed into the lid bottom 2034 and the vent wedge cavity 2120 which may create a vent path 2110. In another implementation, the vent portion 2100, 2100A may be held in with magnets. The lid 2004 may be used with and without the vent portion 2100, 2100A. As depicted in FIGS. 25B, 32B, 36B, and 38A-38C, the vent path 2110 may extend from the spout 2010 to the bottom surface 2084 of the lid 2004. The vent path 2110 may start at the spout 2010 and be created by the tab 2118 splitting the spout 2010. The vent path 2110 may end at the bottom surface 2084 of the lid 2004 with a hole or opening in the bottom surface 2084 of the lid 2004, and opening to the inside of the canister 2002. The vent path 2110 may provide an unrestricted and direct path with the spout 2010 through to the inside of the canister 2002. The vent path 2110 may be any shape or path as long as the ends of the vent path 2110 end up in roughly the same locations. The vent path 2110 may be an angle if the vent 2110 sealed under the spout 2010 and cap 2008 when not in use (i.e., no need for a separate cap for the vent). The vent path 2110 and vent portion 2100, 2100A may help eliminate potential glug sounds and splashing with pouring the container 2000 as depicted in FIGS. 38A-38C. FIGS. 38A-38C depict air flowing throughs the vent path 2110 created by the vent portion 2100 or vent portion 2100A and the tab 2118 within the spout 2010 when pouring the container 2000.

In addition to the various elements described in relation to container 2000 and depicted in FIGS. 16-38C, container 2000 may comprise one or more additional or alternative elements described in relation to containers 100, 300, or 1400 without departing from the scope of these disclosures.

The present disclosure is disclosed above and in the accompanying drawings with reference to a variety of examples. The purpose served by the disclosure, however, is to provide examples of the various features and concepts related to the disclosure, not to limit the scope of the invention. One skilled in the relevant art will recognize that numerous variations and modifications may be made to the examples described above without departing from the scope of the present disclosure.

We claim:

1. A container, comprising:
a canister comprising:
a double wall structure comprising:
an inner wall;
an outer wall;
a first end, configured to support the canister on a surface; and
a second end;
an opening in the second end extending through the double wall structure; and
a neck structure encircling the opening and extending in an axial direction;
a lid adapted to seal the opening, the lid comprising:
a threaded sidewall configured to be received into the neck structure;
a top surface with a spout, wherein the spout extends from the top surface of the lid;
a vent cavity extending from a bottom surface of the lid to the spout; and
a vent body configured to fit into the vent cavity, wherein the vent body, the vent cavity, the spout, and the bottom surface of the lid define a vent that extends from the spout to the bottom surface of the lid and into the canister; and
a cap adapted to resealably seal the spout.

2. The container of claim 1, wherein the vent provides an unrestricted and direct path with the spout through to the canister.

3. The container of claim 1, wherein the vent and vent body eliminate potential glug sounds and splashing when pouring the container.

4. The container of claim 1, wherein the vent body includes one or more protrusions that cooperate and engage with one or more indentations within the vent cavity.

5. The container of claim 4, wherein the one or more protrusions are located on two side surfaces of the vent body and the one or more indentations are located on two side walls of the vent cavity.

6. The container of claim 4, wherein the one or more protrusions and the one or more indentations are in a shape of a diamond.

7. The container of claim 1, wherein the vent body is in a shape of a triangular wedge.

8. The container of claim 7, wherein the vent body includes two side surfaces, a back surface, a sloping surface, and a bottom surface and the vent cavity includes two side walls, a back wall, and a sloping wall.

9. The container of claim 8, wherein the two side surfaces cooperate and engage with the two side walls of the vent cavity, the back surface cooperates and engages with the back wall of the vent cavity, and the sloping surface cooperates and engages with the sloping surface of the vent cavity.

10. The container of claim 1, wherein the double wall structure comprises a sealed vacuum cavity between the inner wall and the outer wall.

11. A container, comprising:
a bottom portion, comprising:
a first end configured to support the container on a surface, wherein the first end has a first outer diameter;
a second end having an opening, wherein the opening has a second outer diameter smaller than the first outer diameter;
a cylindrical wall spaced between the first end and the second end, wherein an outer diameter of the cylindrical wall tapers from the first outer diameter to the second outer diameter along a shoulder chamfer of the cylindrical wall; and
a neck structure encircling the opening and extending in an axial direction;
a lid adapted to resealably seal the opening, the lid comprising:
a threaded sidewall configured to be received into the neck structure;
a top surface;
a spout with a spout opening, wherein the spout extends through the top surface of the lid and a bottom surface of the lid;
a vent cavity extending from the bottom surface of the lid to the spout; and
a vent body located within the vent cavity, wherein the vent body, the vent cavity, the spout, and the bottom surface of the lid define a vent that extends from the spout to the bottom surface of the lid and into the container;
a cap adapted to resealably seal the spout opening; and
a carry handle, rotatably coupled to a cylindrical sidewall of the lid, wherein the carry handle includes a handle index that locks the carry handle at a zero-degree position or horizontal-right, a 90-degree position or vertical, and a 180-degree position or horizontal-left.

12. The container of claim 11, wherein the handle index includes a spring-ball plunger located in the cylindrical sidewall of the lid that cooperates and fits within one or more detents on a handle detent plate located on the carry handle.

13. The container of claim 12, wherein the handle detent plate includes three detents, wherein a first detent cooperates and engages with the spring-ball plunger and locks the carry handle in the zero-degree position or horizontal-right, a second detent cooperates and engages with the spring-ball plunger and locks the carry handle in the 90-degree position or vertical, and a third detent cooperates and engages with the spring-ball plunger and locks the carry handle in the 180-degree position or horizontal-left.

14. The container of claim 11, wherein the handle index includes two or more indexing washers located on a fastener on each side of the carry handle, wherein the two or more indexing washers include one or more grooves and corresponding projections to lock and index the carry handle.

15. The container of claim 11, wherein the carry handle comprises one or more chamfered handle hole openings with a chamfered edge located around a hole on the carry handle for a fastener.

16. The container of claim 11, wherein the carry handle comprises a grip structure and wherein the grip structure is a sleeve and wherein the grip structure has a larger diameter than the carry handle.

17. The container of claim 11, wherein the vent provides an unrestricted and direct path with the spout through to the container and is configured to eliminate potential glug sounds and splashing when pouring the container.

18. A container, comprising:
a canister comprising:
a double wall structure formed of an inner wall and an outer wall comprising:
a first end, configured to support the canister on a surface, wherein the first end includes a base with a base bumper that fits within a circular base slot located on the base, wherein the circular base slot circumferentially extends around the base; and
a second end;
an opening in the second end extending through the double wall structure; and
a neck structure encircling the opening and extending in an axial direction; and
a lid adapted to seal the opening, the lid comprising:
a threaded sidewall configured to be received into the neck structure;
a top surface, comprising:
a spout on the top surface, wherein the spout extends through the top surface and a bottom surface of the lid; and
a removable cap adapted to resealably seal the spout;
a vent cavity extending from the bottom surface of the lid to the spout; and
a vent body located within the vent cavity, wherein the vent body, the vent cavity, the spout, and the bottom surface of the lid define a vent that extends from the spout to the bottom surface of the lid and into the container.

19. The container of claim 18, wherein the base bumper is formed from a polymer material and configured to add friction to the base and the container when opening and closing the lid or removable cap on the surface.

20. The container of claim 18, wherein the vent provides an unrestricted and direct path with the spout through to the canister and is configured to eliminate potential glug sounds and splashing when pouring the container.
